(19) United States
(12) Patent Application Publication
(10) Pub. No.: US 2009/0048962 A1
(43) Pub. Date: Feb. 19, 2009

(54) Interactive Security Brokerage System

(76) Inventors: Kevin F. Harrington, Huntington, NY (US); James R. Wheeler, Yardley, PA (US); Kenneth Torres, Ossining, NY (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 12/186,501

(22) Filed: Aug. 5, 2008

Related U.S. Application Data
(63) Continuation of application No. 10/346,022, filed on Jan. 15, 2003.
(60) Provisional application No. 60/349,738, filed on Jan. 16, 2002.

(51) Int. Cl. G06Q 40/00

(52) U.S. Cl. 705/37

(57) ABSTRACT

The present invention provides an interactive browser based system providing market information regarding municipal bonds which allows users to search for, identify, analyze, compare, auction and/or purchase municipal bonds.

### RELATED U.S. APPLICATION DATA

Provisional application No. 60/349,738, filed Jan. 16, 2002

### FIELD OF THE INVENTION

The present invention relates to a system for providing descriptive data information regarding securities traded over-the-counter, and, more particularly, to an interactive system that allows users to search for, identify, analyze, compare, offer, bid on and/or purchase municipal bonds.

### BACKGROUND OF THE INVENTION

Bonds are debt obligations, most often interest-bearing, issued by large corporations and governmental organizations as a means of generating cash. A bond is a certificate obligating the issuing party to make regular interest payments to the bond holder. The purchase price of the bond constitutes a loan to the bond's issuer. Unlike conventional loans, however, bonds are tradable. The party purchasing the bond can withdraw from the transaction by selling the bond in the over-the-counter market. In exchange for the loan, the issuer pays the holder a specified amount of interest and refunds the principal on a specific date. The date that the principal becomes due is referred to as the bond's “maturity date.”

Municipal bonds are debt obligations issued by state and local governments in order to support general financing needs or special projects. Interest paid on municipal bonds is usually free of federal tax and, under certain circumstances, may be free of state and local taxes as well.

Upon sale of a bond, the issuer provides a certificate to the purchaser, setting out the loan terms. The bond certificate represents a contract obligating the issuer to repay the loan together with any interest promised. The certificate is a negotiable instrument that the holder can sell in the bond market. Further, the bond issuer can simply repurchase the certificate after issue in accordance with stated call options on the bond and be relieved from any further obligations. The transferability of bonds makes them an attractive investment choice, thereby lowering the cost of borrowing for the issuing party.

When bonds are first offered as new issues, the initial trading is done in the primary market, where the money raised from the sale of the bonds goes directly to the issuer for its use. Subsequently, the bonds can be bought and sold among other investors. This is referred to as the secondary market. The secondary market provides liquidity to buyers of the bonds, who are now able to sell the bonds before the maturity date, should they wish to do so. The pricing of bonds in the secondary market is dependent upon supply and demand, and the prevailing interest rates, among other factors. Bonds in the secondary market are not traded at a physical market as are stocks. Rather, they are traded “over-the-counter” in the bond trading rooms of exchanges and brokerage firms.

Since it is difficult for bond investors to find individual buyers or sellers, they usually go to professional “market-makers” who buy and sell bonds for them. Market-makers are banks and security houses that broker purchases and sales for individual clients, earning a commission on each transaction. When a market-maker needs a purchaser to complete a sale or an inventory of bonds to complete a purchase, it may enlist the services of a “broker's-broker” who deals exclusively with dealers and dealer banks, and not with members of the general public.

An investor wanting to sell a bond would go to a market-maker, either directly or through a broker/dealer, who usually makes a market with two prices: a “bid” price and an “offer” price. The investor may sell bonds to the market-maker at the “bid” price, or buy at the “offer” price. The difference between the bid and offer price is called the “spread.” The market-maker makes money on these transactions by buying at a lower bid price and selling at a higher offer price. The broker's-broker, in turn, buys from a selling market-maker and sells to a buying market-maker, and works for a stated commission.

Normally, when investors wish to sell bonds they contact their broker who may be a market maker in the bonds. The investor may offer to sell the bonds at a stated price, known in the industry as an “Offering.” In the alternative, the investor may request his or her broker to solicit bids for the bonds in the over-the-counter bond market. This solicitation is known as a “Bid Wanted.”

The investor's broker may bid the bond directly or advertise the bonds as a bid wanted, utilizing the services of a broker's-broker. If the bonds are sold, the investor receives the proceeds of the sale, less any commission and fees.

As can be appreciated, it is critical to the bond trading market to have accurate and current information in order to effectuate trades efficiently and profitably. Having more accurate and current information allows the bond market participants to accomplish these goals.

In presently available electronic-based municipal bond trading systems used by a broker or broker's broker, as illustrated in FIG. 1, the prospective purchaser is informed of the availability of a particular bond and is afforded the opportunity to bid on it at auction. The system may automatically determine the highest bidder, thereby enabling the bond to be traded or sold. Such systems, however, do not provide the user with the opportunity to interact with the system, to search for particular bonds in accordance with the user's preferences, to arrange and customize information about such bonds in a way that best suits or is most helpful to the user, to store and retrieve such information, to calculate the overall cost of a proposed bid, or to participate in the bidding and purchasing process.

For example, U.S. Pat. No. 5,915,209 discloses a computerized municipal bond trading system capable of conducting a private electronic auction of bids between the central market maker and multiple remote clients who are prospective bidders. As detailed by the patent, a broker compiles lists of bonds received from various traders and firms into a central listing of offerings. Offerings which have not traded are included in a silent auction. Traders participate in silent auctions, with secret bidding, and rely on brokers to run these silent auctions. This system merely teaches a method for electronically conducting a silent auction via facsimile. It is not interactive with the user and does not permit the user to search various criteria.

Similarly, U.S. Pat. No. 6,161,099 discloses an apparatus and process for conducting municipal bond auctions, over electronic networks. In this system, the auctioneer maintains a web site from which information about bonds to be auctioned can be obtained. A user participates in the auction by accessing the web site via a conventional Internet browser and is led through a sequence of screens that perform the functions of verifying the user's identity, assisting the user in preparing a bid, verifying that the bid conforms to the rules of the auction, displaying to the user during the course of the auction selected bid information regarding bids received, and informing the bidder how much time remains in the auction. This invention establishes communications over a network between an auctioneer's computer and bidders' computers and provides information regarding financial instruments to be sold to potential bidders at auction. Again, the system merely serves to facilitate silent auctions and does not provide for user interaction.

### SUMMARY OF THE INVENTION

According to the preferred embodiment of the present invention, an electronic-based interactive system is provided whereby users may (1) access the system from a remote location; (2) post bond offerings and/or bid wanteds; (3) make search requests that will enable the user to obtain all available information about offerings or bid wanteds that fall within the parameters of the request; (4) make calculation requests to perform a calculation to determine the overall cost of purchase or expenses associated with a sale; (5) create trade reports and a history of a customer's recent activity; (6) bid on and execute purchases and trades of bonds; and (7) provide “back office” services for completed trades such as recording trades for submission to the relevant regulatory bodies and managing the proceeds of trades.

The present invention also provides an electronic-based bond purchasing system that allows prospective purchasers to interact with the system to identify, analyze and compare various bonds according to the prospective purchaser's preferences.

It is yet another advantage of the present invention that prospective purchasers can store and retrieve the parameters used to formulate a search as well as the results of the search.

### BRIEF DESCRIPTION OF THE DRAWINGS

FIG. 1 is a flow chart illustrating the existing prior art.

FIG. 2 is a flow chart illustrating the overall operation of the present invention.

FIG. 2a is a flow chart illustrating the search request feature of the present invention.

FIG. 3 is an image of the present invention's entry point.

FIG. 4 is an image of the present invention's Bid Posting feature.

FIG. 5 is an image of the present invention's Offerings Search feature.

FIG. 5a is an image of the present invention's Offerings Search feature with certain parameters selected by the user.

FIG. 6 is an image of the results returned from a sample search run using the present invention's Offerings Search feature.

FIG. 6a is an image of detailed information as to a particular bond search.

FIG. 7 is an image of the detailed information provided by the present invention as to a particular bond offering.

FIG. 8 is an image of the Customer Extension Box feature of the present invention.

FIG. 9 is an image of the present invention's “By State” search feature.

FIG. 10 is an image of the available offerings of a particular state presented by the present invention's “By State” search feature.

FIG. 11 is an image of the present invention's Watch List feature.

FIG. 12 is an image of an offering selected for the present invention's watch list.

FIG. 13 is an image of the present invention's Offerings By Type and Offerings By Region search features.

FIG. 14 is an image of the present invention's New Issue feature.

FIG. 15 is an image of the present invention's Markets display feature.

FIG. 16 is an image of the present invention's Hot List display feature.

FIG. 17 is an image of the present inventions Ladder display feature.

FIG. 18 is an image of the present invention's Upload feature.

FIG. 19 is an image of the present invention's Scales search feature.

FIG. 20 is an image of the invention's By Par Amount Icon.

FIG. 21 is an image of the present invention's Bid Wanteds By Feature search page.

FIG. 22 is an image of the present invention's Bid Wanteds By Type/By Region search feature.

FIG. 23 is an image of the present invention's Bid Wanteds By State search feature.

FIG. 24 is an image of the present invention's Bid Wanteds by Number search page.

FIG. 25 is an image of the present invention's Bid Wanteds by Blocks feature.

FIG. 26 is an image of the present invention's Bid Wanteds by Reoffered search feature.

FIG. 27 is an image of the present invention's Quoted Bonds search feature.

FIG. 28 is an image of the present invention's Multiple Bid Request feature.

FIG. 29 is an image of the present invention's Will Bid and Pass feature.

FIG. 30 is a flow chart illustrating the calculation request feature of the present invention.

FIG. 31 is an image of the present invention's C-Wire feature.

FIG. 32 is an image of the present invention's Bid Request search feature.

FIG. 33 is an image of the present invention's My List feature.

FIG. 34 is a flow chart illustrating the bid/purchase request feature of the present invention.

FIG. 35 is an image of the present invention's third-party service.

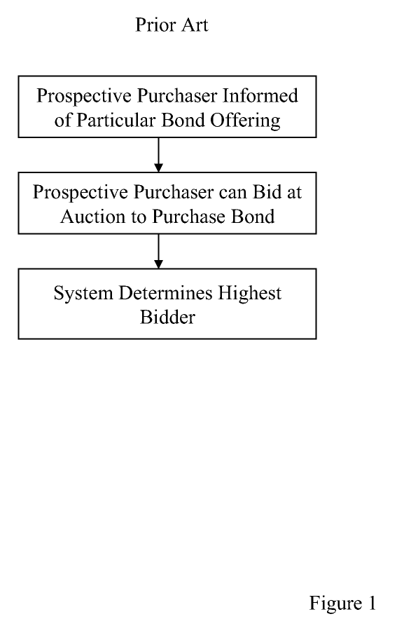

### DETAILED DESCRIPTION OF THE INVENTION

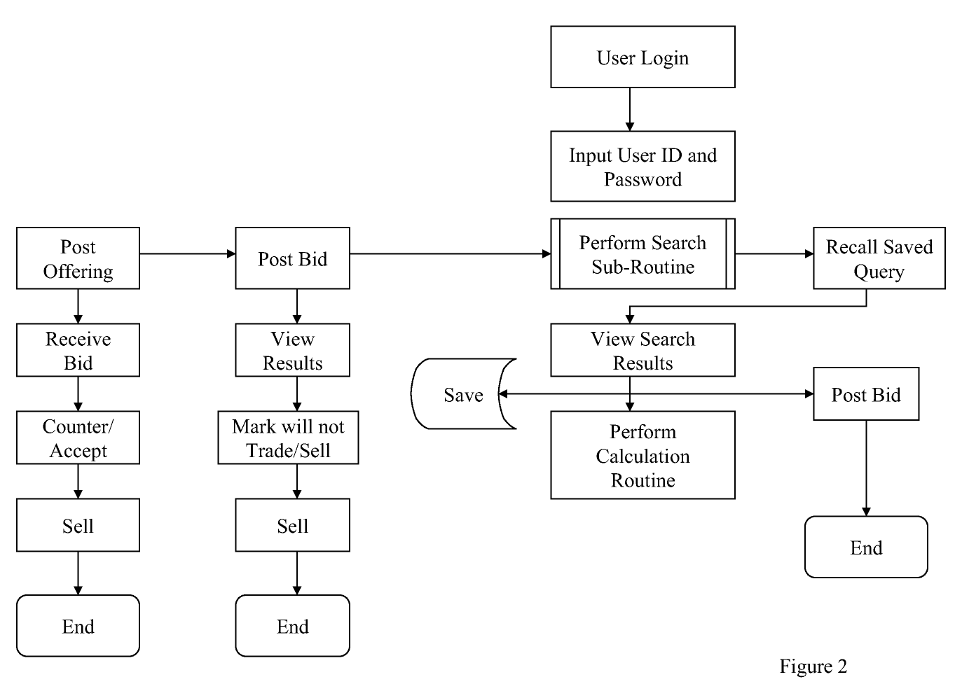

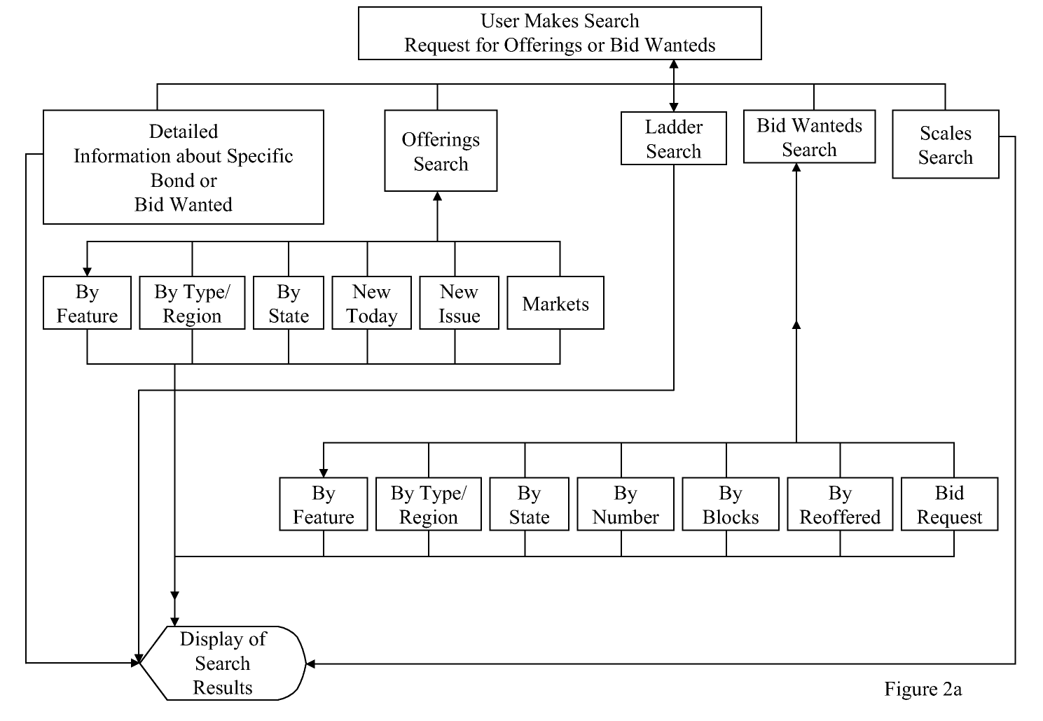

The present invention concerns municipal bonds and other securities traded in a comparable manner as will be apparent to those skilled in the art. According to the preferred embodiment of the invention, as detailed in FIG. 2, an electronic-based system is provided whereby a user may: 1) interact with the system in order to post bond offers or bid wanteds; 2) offer to purchase bonds or respond to bid wanteds; 3) make search requests that will enable the user to obtain all available information about municipal bond offerings or bid wanteds that fall within the parameters of the request; 4) store search queries and search results; 5) make calculation requests to perform a calculation to determine the overall cost of purchase or sale; 6) bid on and execute purchases and trades of bonds; and 7) provide back office services for completed trades such as recording trades for submission to the relevant regulatory bodies and managing the proceeds of trades.

A market maker/broker with a customer wishing to sell his or her bonds may bid their customer directly, or utilize the invention's Bid Wanted feature which provides an electronic market for bond dealers nationwide.

Depending on the direction of the bond market, the investor may be able to receive a better price utilizing the invention than if he or she had sold at the initial price quoted by the broker. Prospective bidders performing a “search” request will obtain detailed information on available offers and bid wanteds about particular bonds, or may request a list of bonds that fall within certain user-selected parameters, for the purpose of comparing such bonds and determining which bonds the user may wish to bid on. Further, the preferred embodiment allows a user to store and retrieve for later use both the search parameters and the results of any search request.

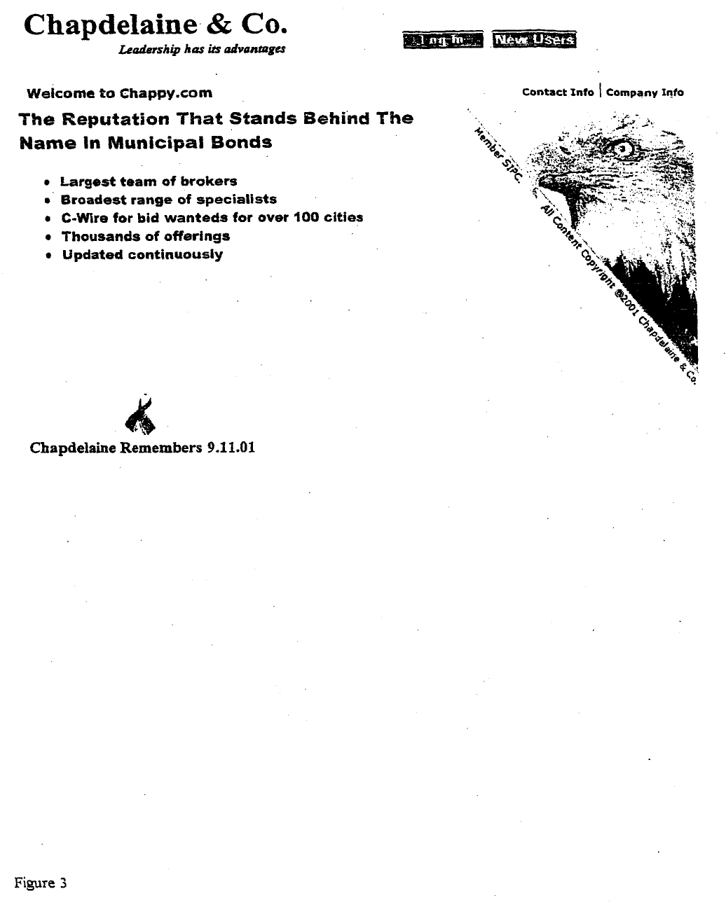

In the preferred embodiment of the present invention, the system is accessed through an Internet browser. Upon accessing the system, the user is presented with the system's home page as shown in FIG. 3. At this point, the user can either log into the system or indicate that he or she is a new user.

The system of the present invention is limited to users who are licensed and registered with the Securities and Exchange Commission, the National Association of Securities Dealers and/or the Municipal Securities Rulemaking Board (MSRB) and are required to meet regulatory requirements. After establishing these credentials, a unique user name and password are issued to the user.

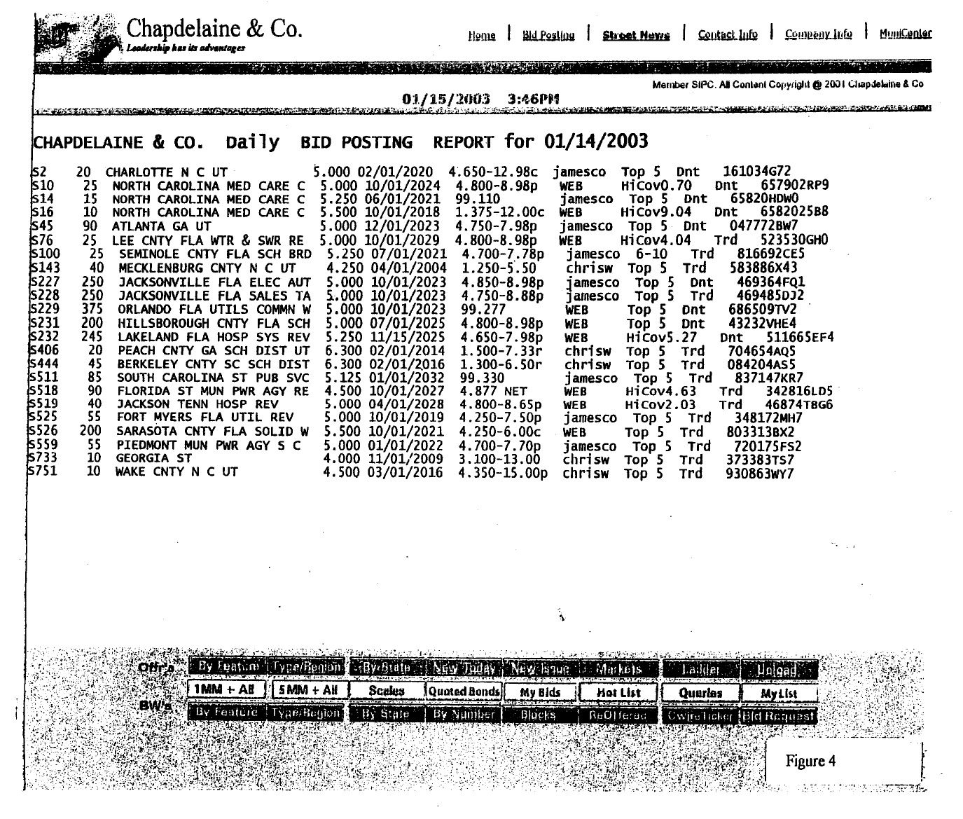

Once a user name and password are issued, the user may log into the system. Following successful authorization, the system opens to the Bid Posting Page, as shown in FIG. 4. The Bid Posting Page provides a review of the user's prior bids and the user's status with respect to the other bidders. At this point, the user may review his or her previous bids or elect to perform a search of offerings and bid wanteds posted on the system. In performing a search, the user can locate only those bonds having certain features by using the color-coded icons appearing at the bottom of the screen as shown in FIG. 4.

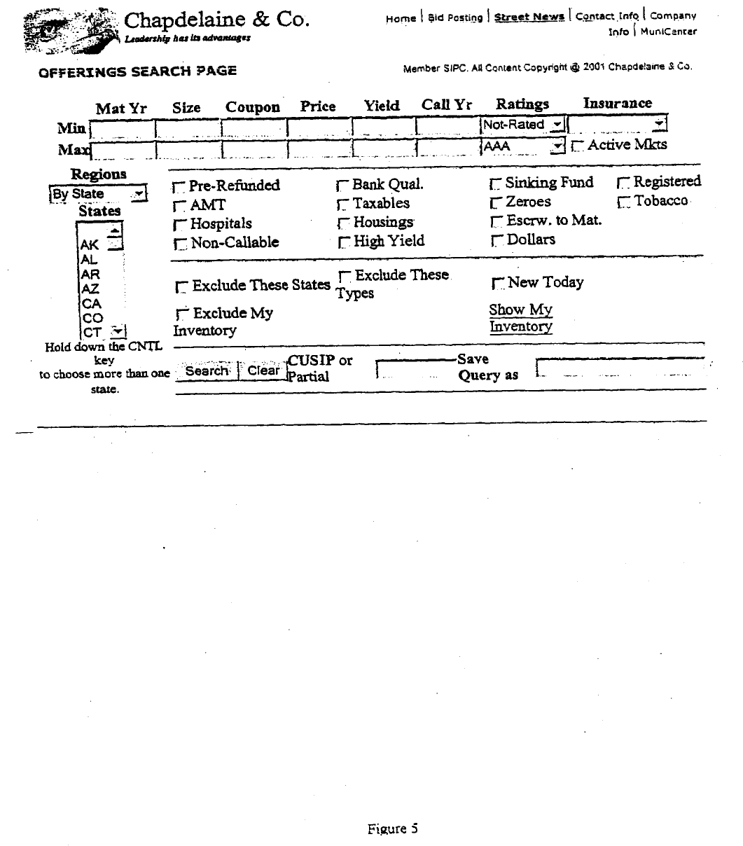

Selection of the offerings icon designated “By Feature” brings up the Offerings Search page as shown in FIG. 5. There exist a number of different searches and search parameters that may be specified in order to identify particular offerings in which the user is interested. For example, the user may perform interactive searches of bonds by state, region, size, coupon, price, yield, call year, ratings and other recognized market parameters as illustrated in FIG. 5. Further, the user can set minimum and maximum values for each of these parameters to further limit the search. In addition, the user can include or exclude certain types of bonds from a search such as those identified in FIG. 5. Each parameter may be selected by “clicking on” (i.e., selecting with a mouse) an interactive display containing icons specifically assigned to each of the available parameters as illustrated in FIG. 5a. Such displays and icons are specifically designed for convenience and ease of use, so that searches may be performed within seconds. Searches may also be performed using more than one user-selected parameter, i.e., to identify bonds that fall within multiple user-selected parameters. An example of the Offerings search page with certain search parameters selected is illustrated in FIG. 5a.

Any search run by the user on the Offerings Search page can be saved for future use. To exercise this option, the user enters a name for the search in the “Save Query As” box and selects the “Search” icon illustrated in FIG. 5. The user's query will be automatically saved. To rerun the search at a future time, the user selects the “Queries” icon at the bottom of the screen and chooses the name under which the search was saved.

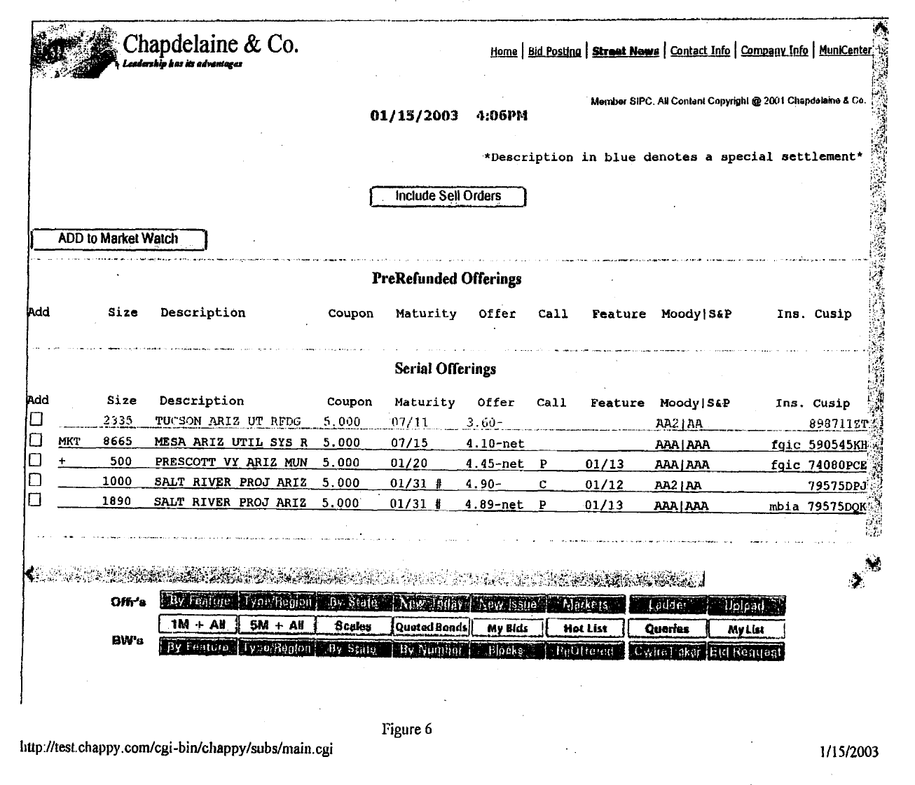

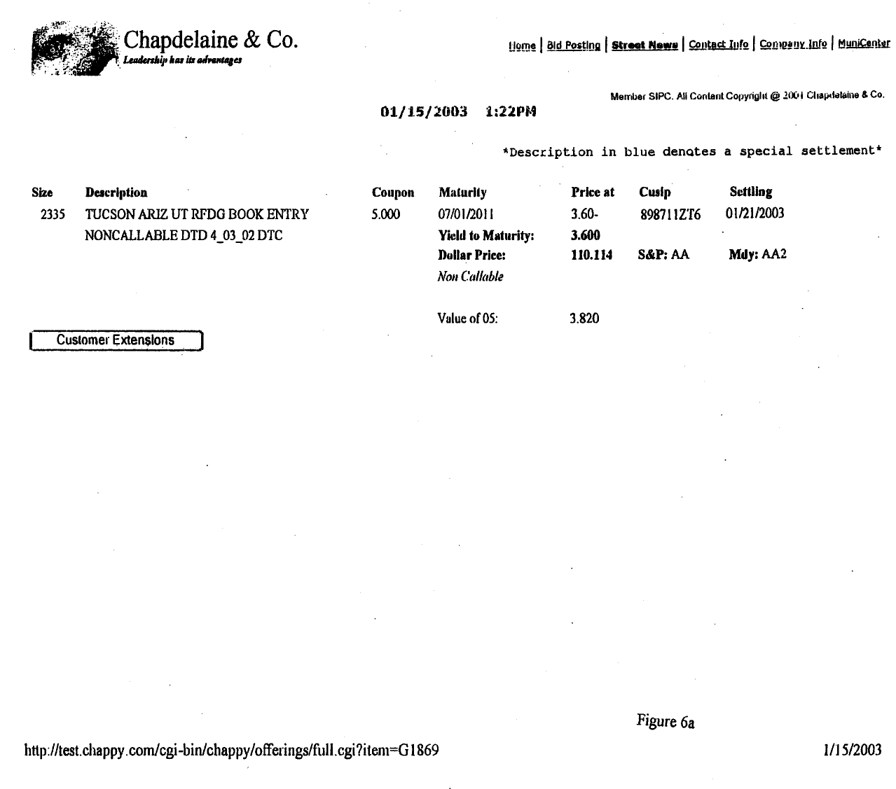

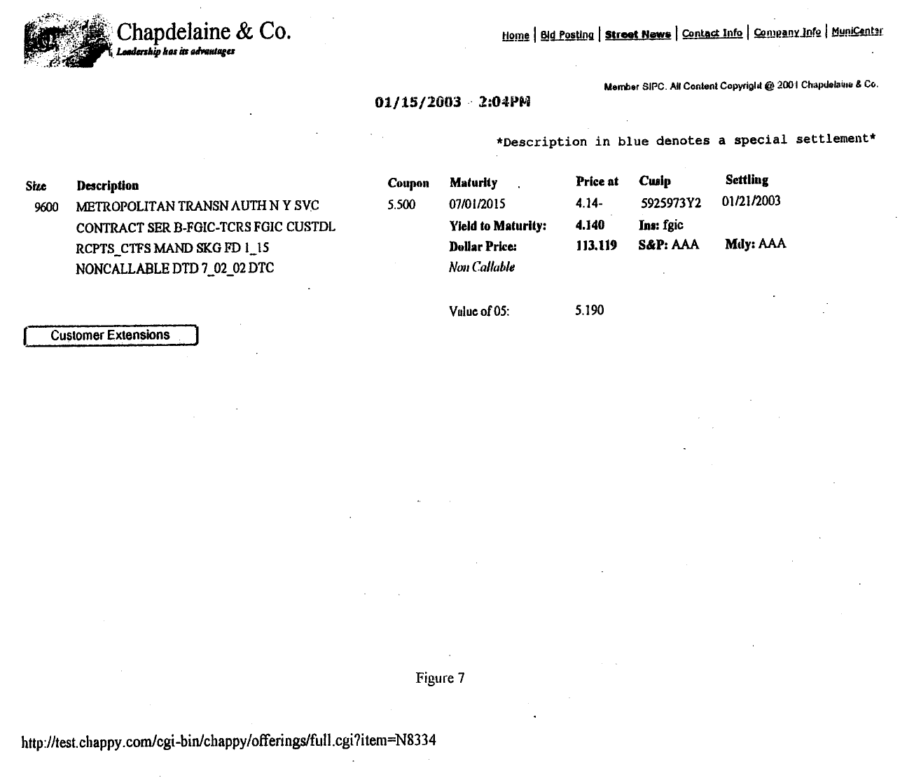

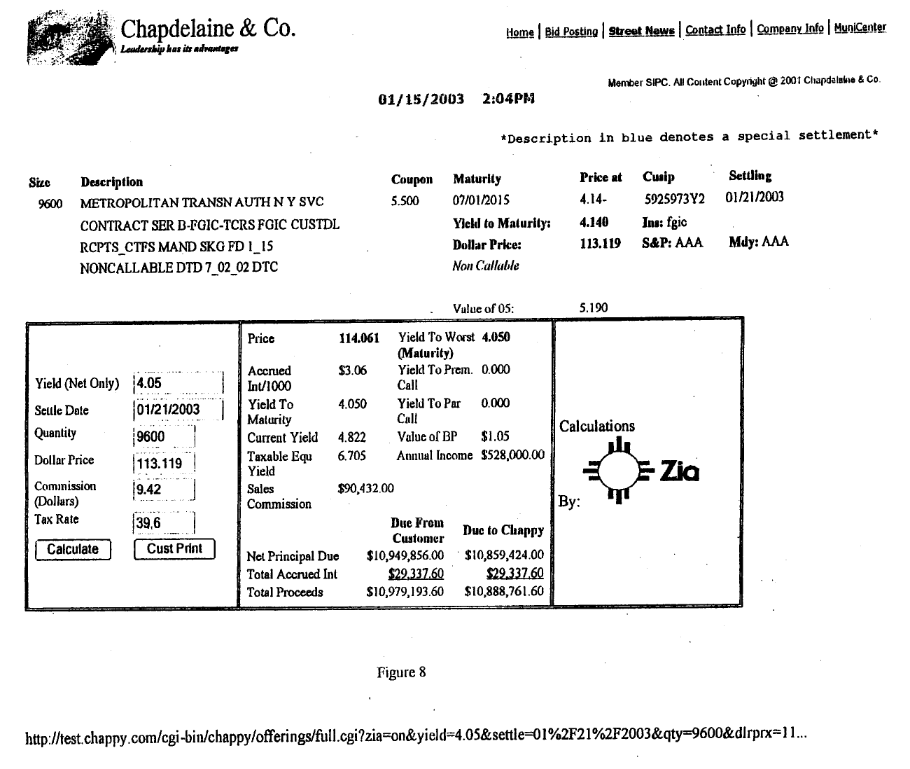

Following selection of the “Search” option, the screen is refreshed and the offerings meeting the user-selected criteria will appear, as shown in FIG. 6. At this point, the user is able to select any resulting offering in order to obtain more detail, as illustrated in FIG. 6a, or add one or more offerings to the “Market Watch,” as shown in FIG. 6 and as discussed below. Once a particular offering is selected, the screen will be refreshed and more details about the bond offering will appear, as shown in FIG. 7. Also, shown there will be a Customer Extension Box. The Customer Extension Box allows the user to adjust any of the boxes to specific individual requirements, such as Yield, Settle Date, Quantity, Dollar Price, Commission and Tax Rate. After selecting a particular extension, the user may adjust the parameters of that extension. For example, the user may elect to vary the yield in order to determine the corresponding commission. The user then selects the “calculate” option and the remaining parameters are recalculated as shown in FIG. 8, to reflect the cost of purchasing and/or selling the bond, taking into account the selected parameters.

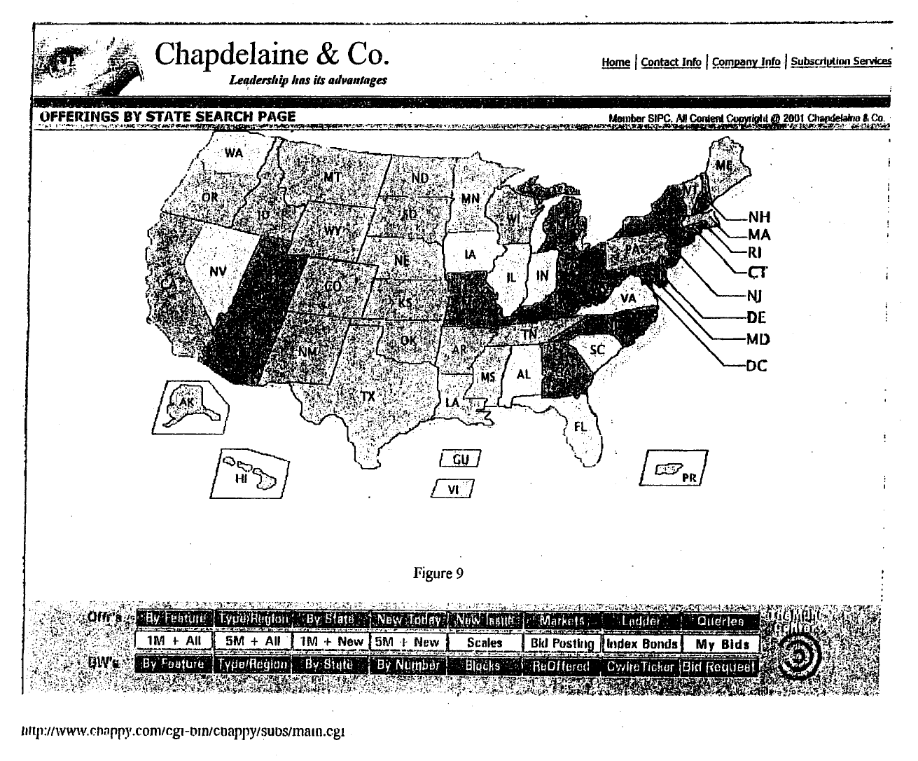

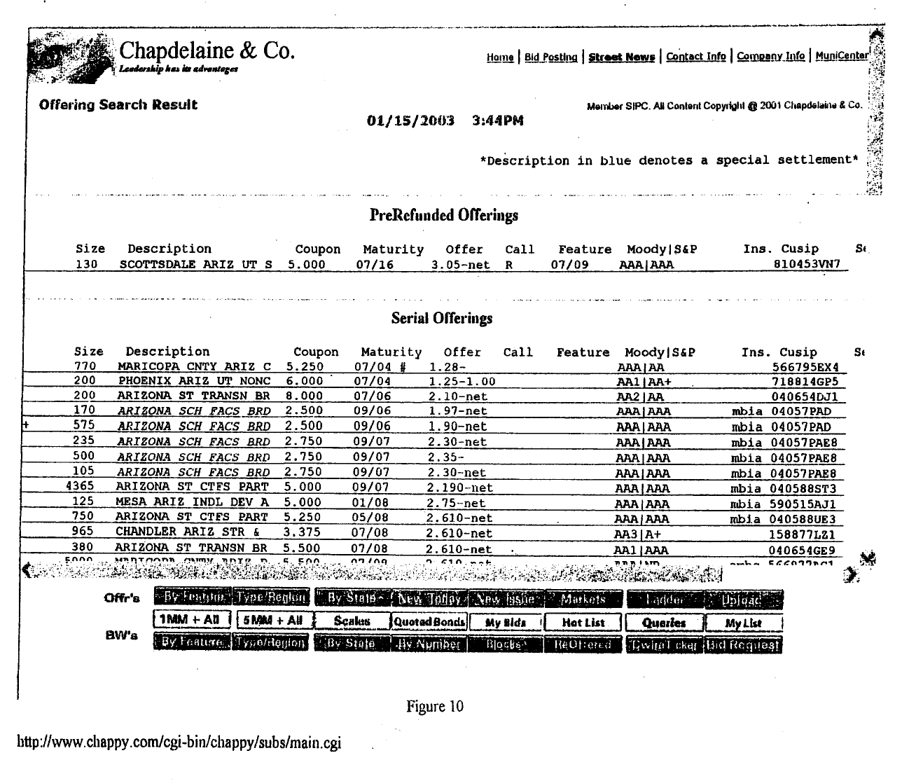

If a user desires to search only offerings in certain states, the “By State” icon is selected. At this time, a map of the United States with each individual state outlined and containing the United States Postal Service's two-letter state abbreviations will appear, as illustrated in FIG. 9. Each state abbreviation serves as an interactive icon. When a particular state is selected, the corresponding offerings from that state are displayed, as illustrated in FIG. 10. The bonds are displayed by maturity date, beginning with pre-refunded bonds and followed by serial offerings. Again, the user may click on a particular offering to view a detailed description and a customer extension box.

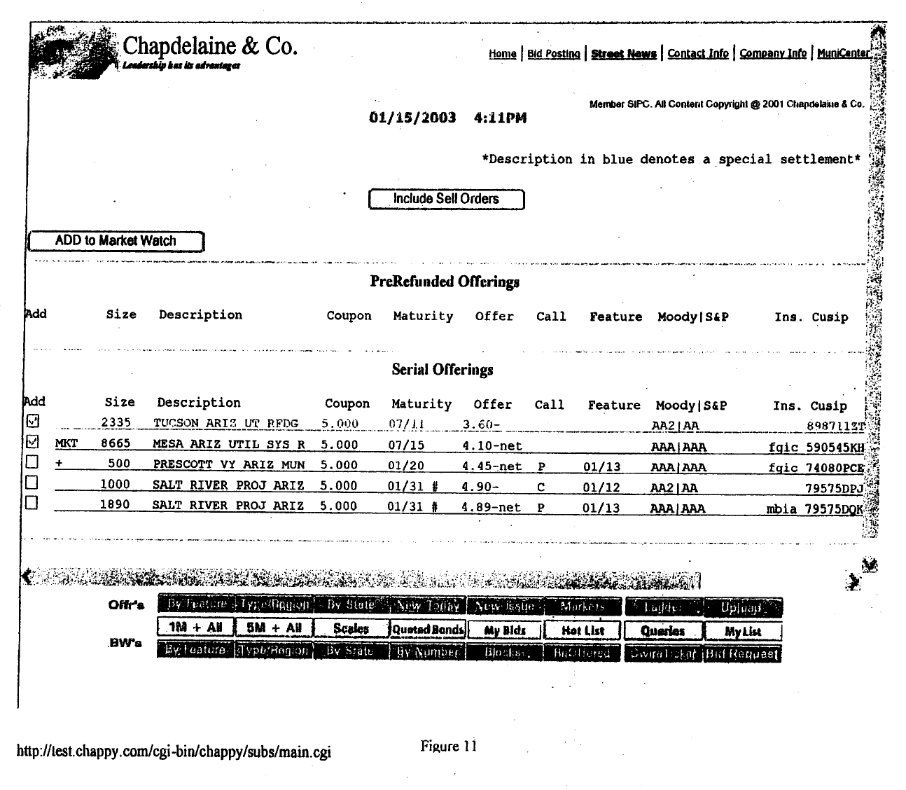

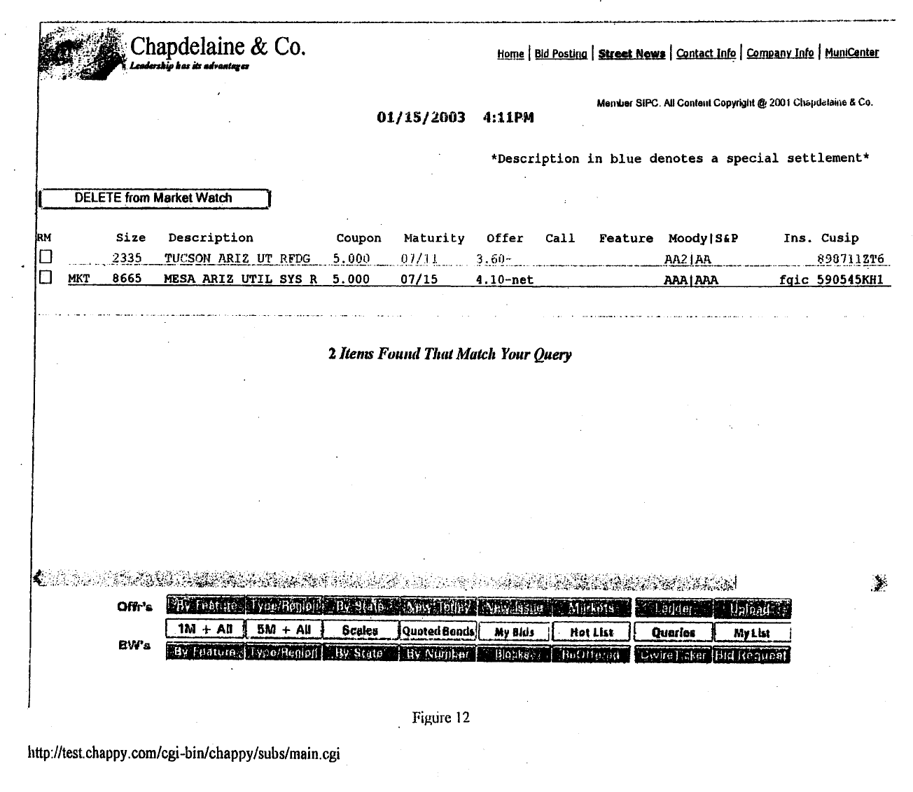

Also available on the system of the present invention is the Watch List feature, as illustrated in FIG. 11, which allows the user to mark, store, and retrieve bonds that are of interest to the user. This feature allows the user to view and attach an offering to a personal “shopping basket” which allows the user to set aside bonds of interest, and then monitor the progress of pricing and/or bidding on such bonds. When the user selects a displayed offering for the Watch List, the invention will fill the space with the selected offering in its current form, as illustrated in FIG. 12. This feature is available to the user for any offering, and is retrievable via the “By Feature” icon. Selections for the Watch List may also be deleted from the list as the user desires.

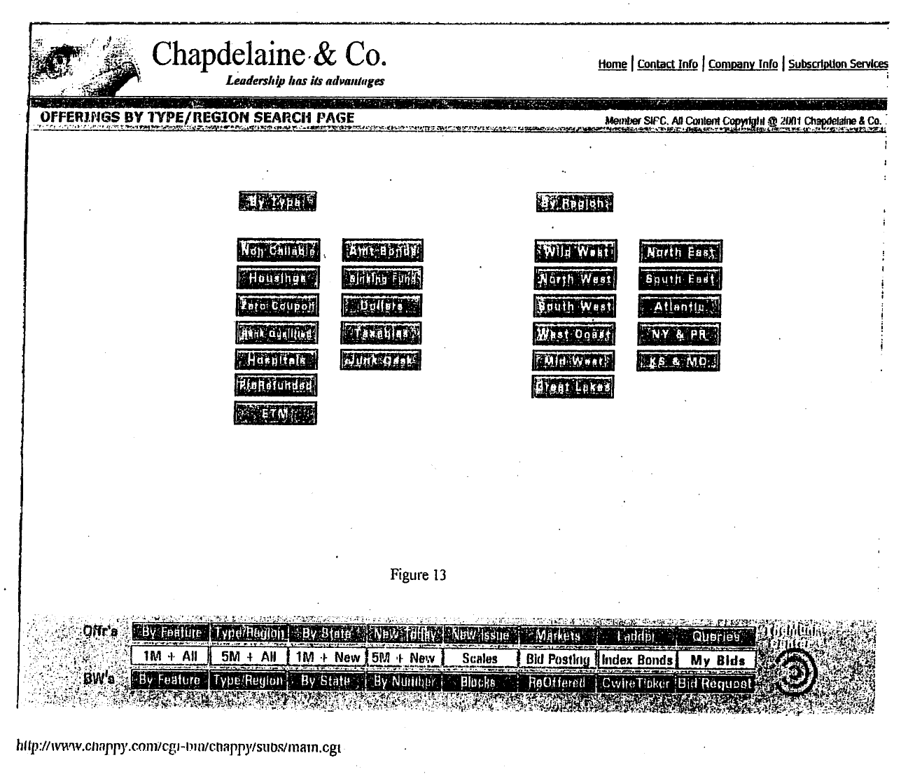

As illustrated in FIG. 13, the user may also search the Offerings “By Region” or “By Type.” The former enables a user to display Offerings in any one of the regions shown in FIG. 13. The bonds in that region are listed in maturity order.

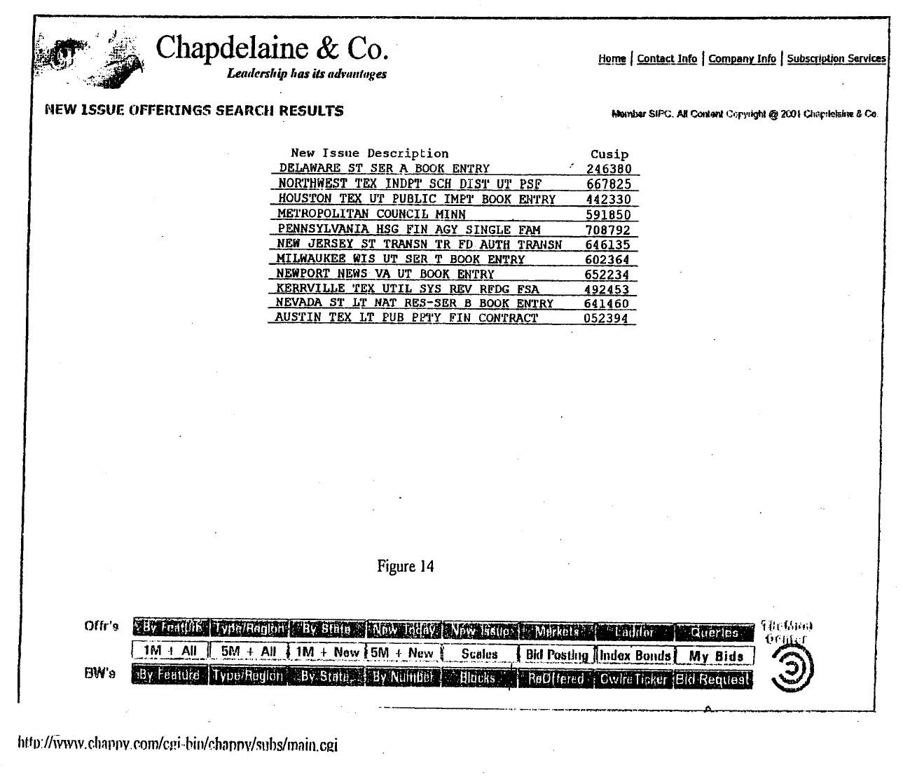

The By-Type feature enables a user to search Offerings relating to one of many different bond types including: non-callable, Housing, Zero coupon, bank qualified, Hospitals, Pre-refunded, Escrowed to Maturity (ETM), AMT Bonds, Sinking Fund, Dollars, Taxable, Junk Bonds and Tobacco Bonds. In addition, a user may search offerings using the “New Today,” or “New Issue” search features. The New Today feature only displays items that are new listings on the site that were not listed on the previous day. The New Issue feature displays only those items from the most recent issues, as shown in FIG. 14.

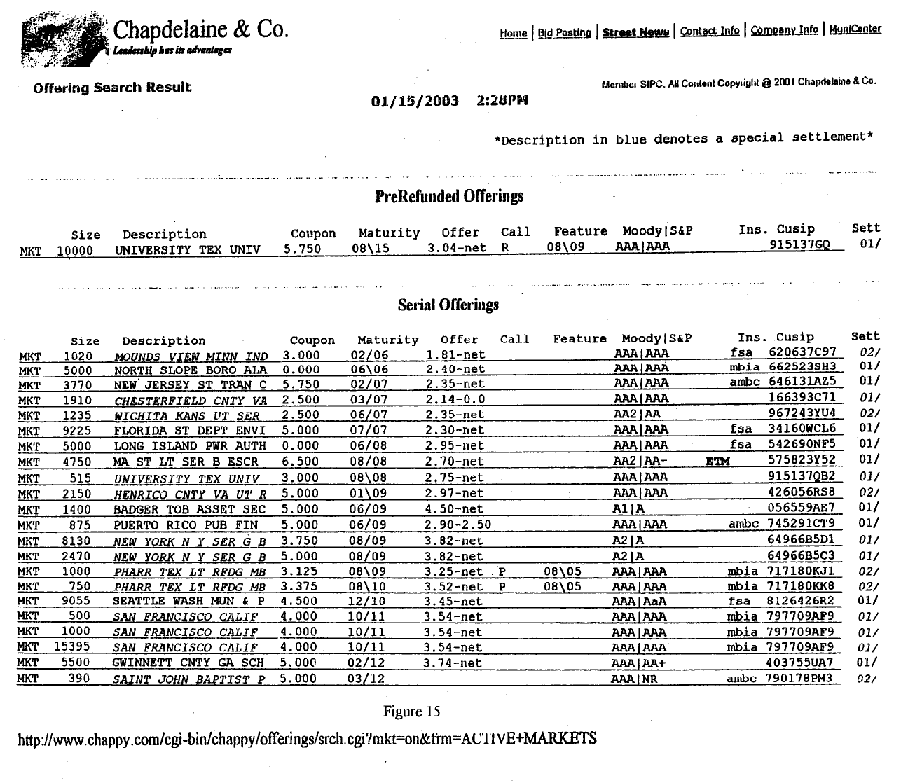

Also available for the user are special searches labeled “Markets,” “Hot List” and “Ladder.” The Markets feature allows the viewer to display all bond offerings on the system that have a current market on both the bid side and the offered side, as shown in FIG. 15.

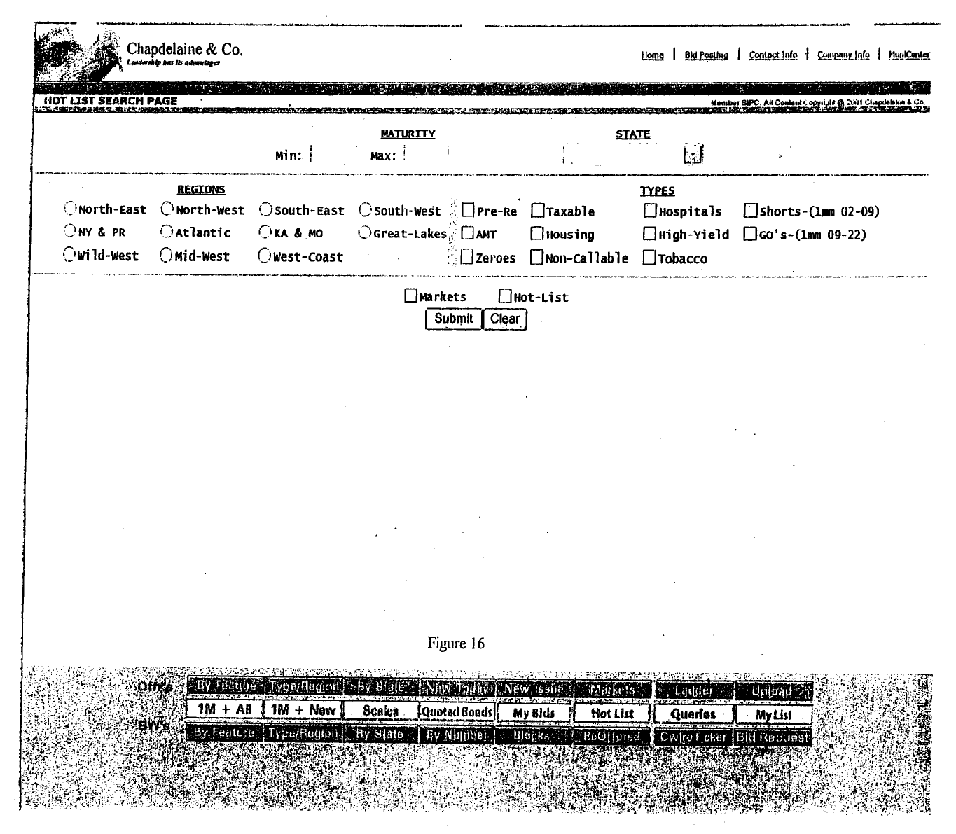

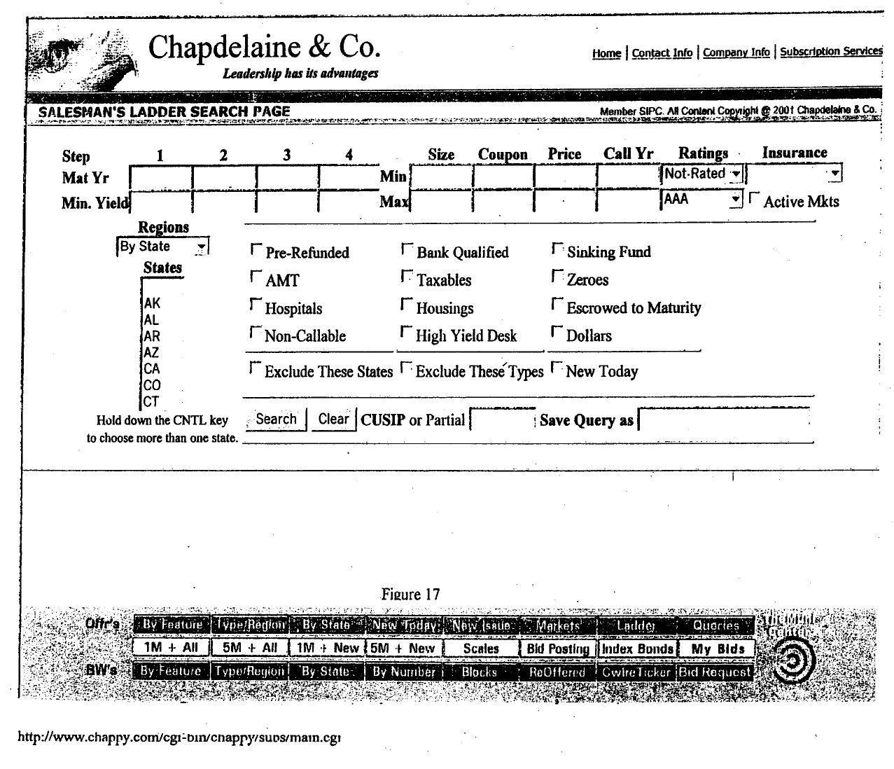

As illustrated in FIG. 16, the Hot List page is an extension of the Markets page. This feature allows a quick search by region, type, state or maturity of any item that the system has a market on both the bid side and offered side, rather than utilizing the market button which shows all markets. The Ladder feature, which allows the user to specify a set of search parameters to be used over a broad maturity range yield of municipal bonds, is illustrated in FIG. 17.

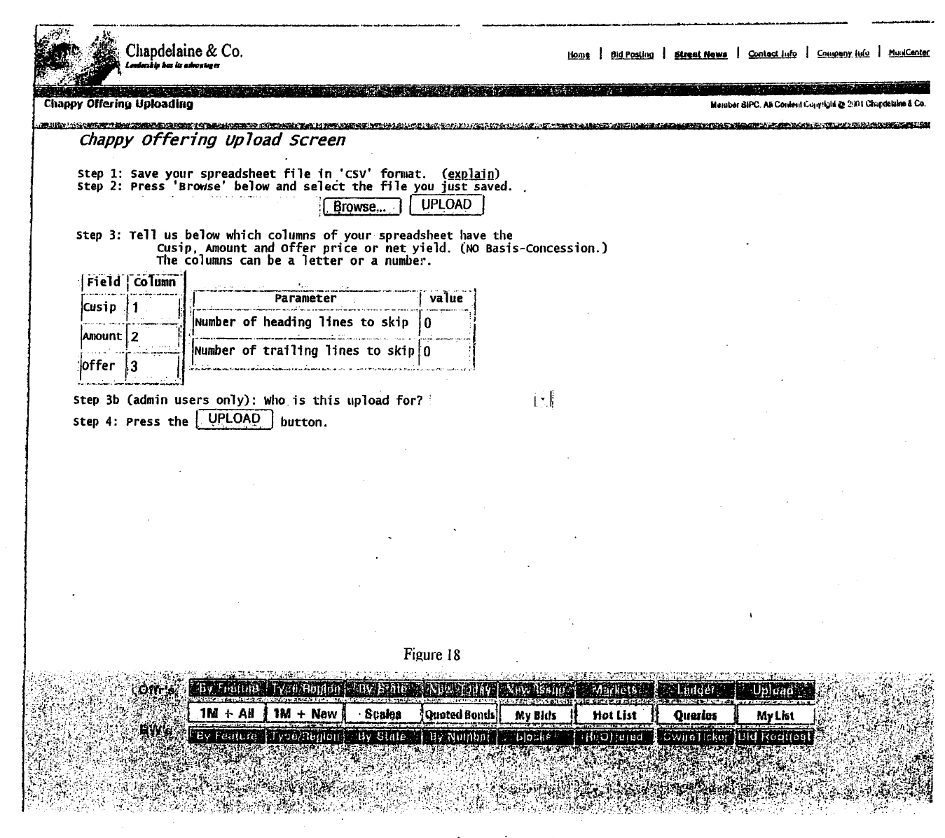

Also available for bond offerings is a special feature labeled “Upload.” As illustrated in FIG. 18, the “Upload” feature allows an approved user to upload a list of bond offerings directly into the brokerage system, via a spread sheet computer program. Authorization for use of this feature is discretionary and requires special user access authorization.

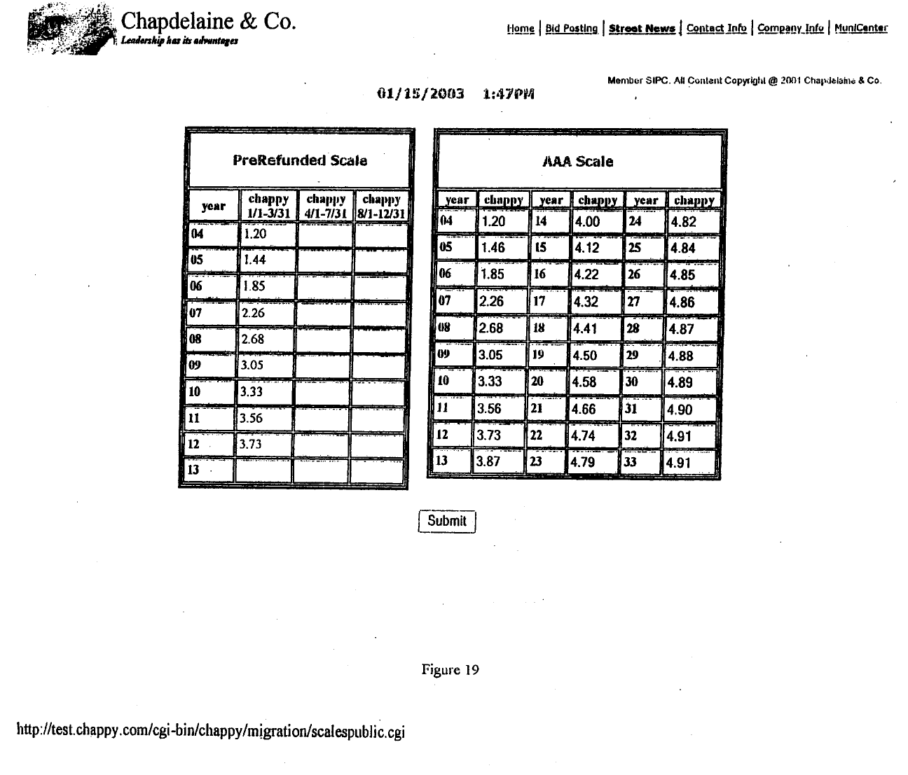

A particularly useful search tool that is unique to the present invention is the “Scales” feature that allows the user to view pre-refunded and AAA/Insured bond scales that are prepared and updated on a daily basis as illustrated by FIG. 19. These features allow searches to be performed by the user over a broad range of municipal bonds, while at the same time affording the user current and up-to-date information.

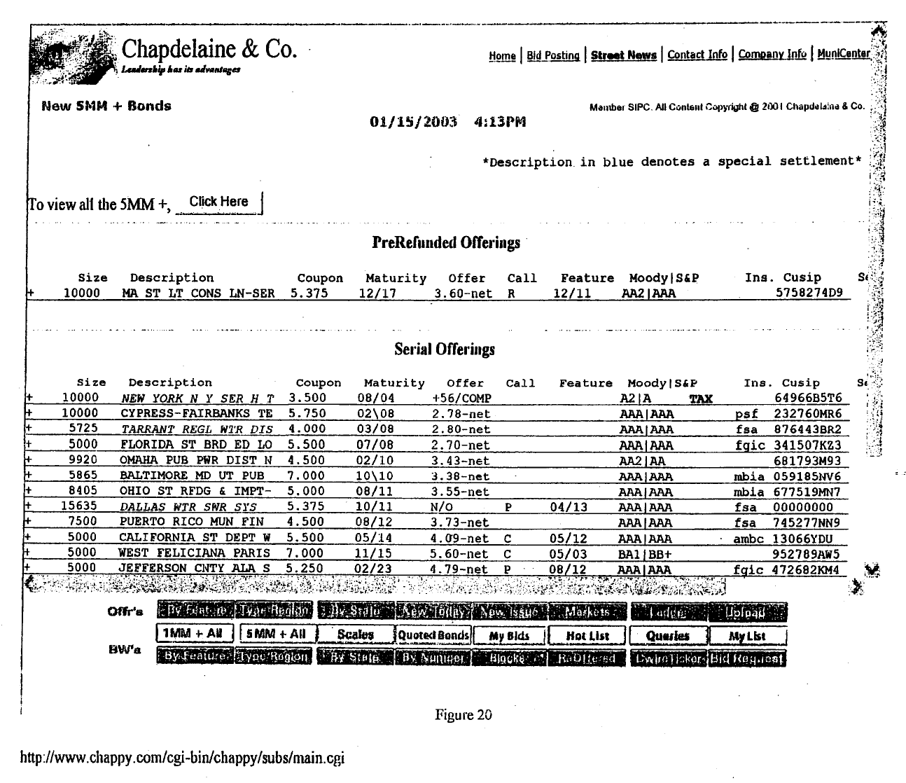

The present invention's By Par Amount icon enables the user to select the par amount desired from the Offerings searches, as illustrated in FIG. 20.

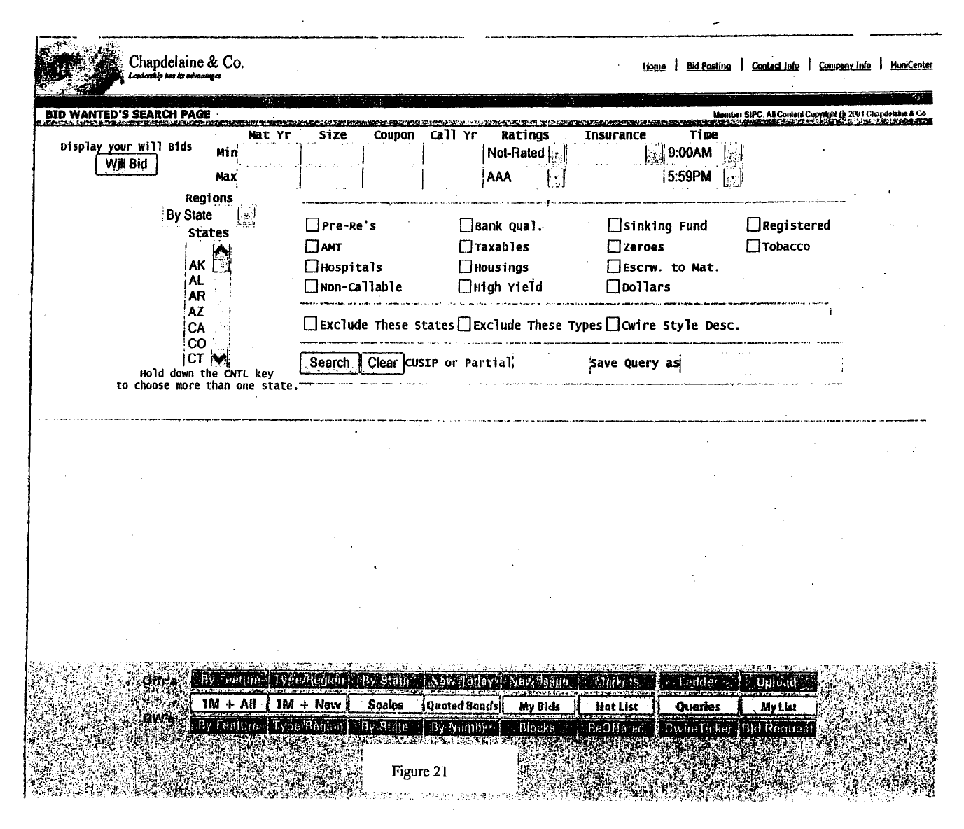

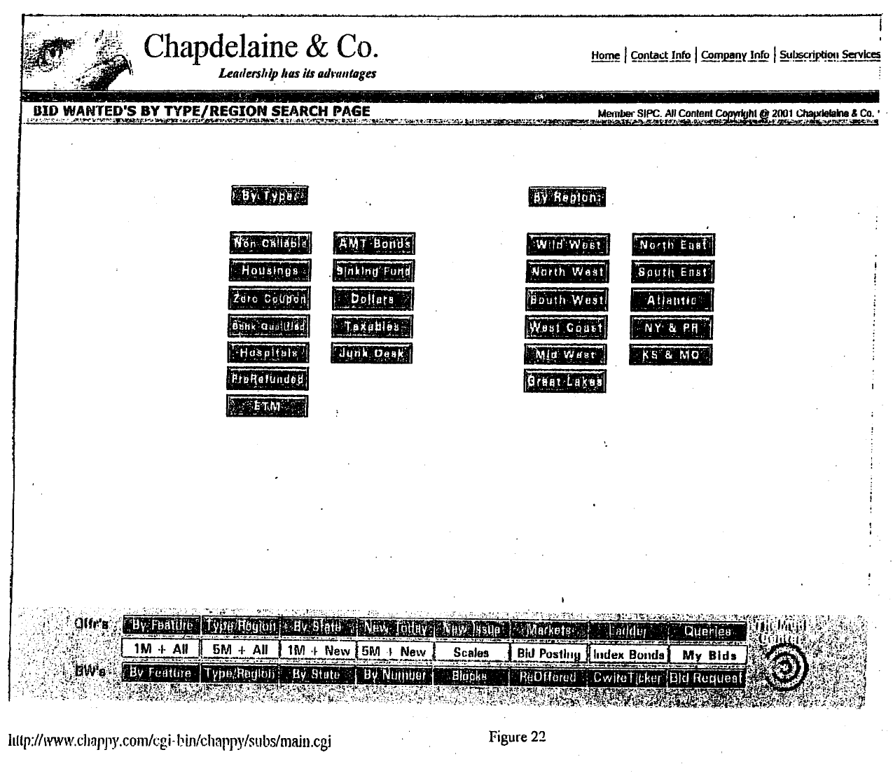

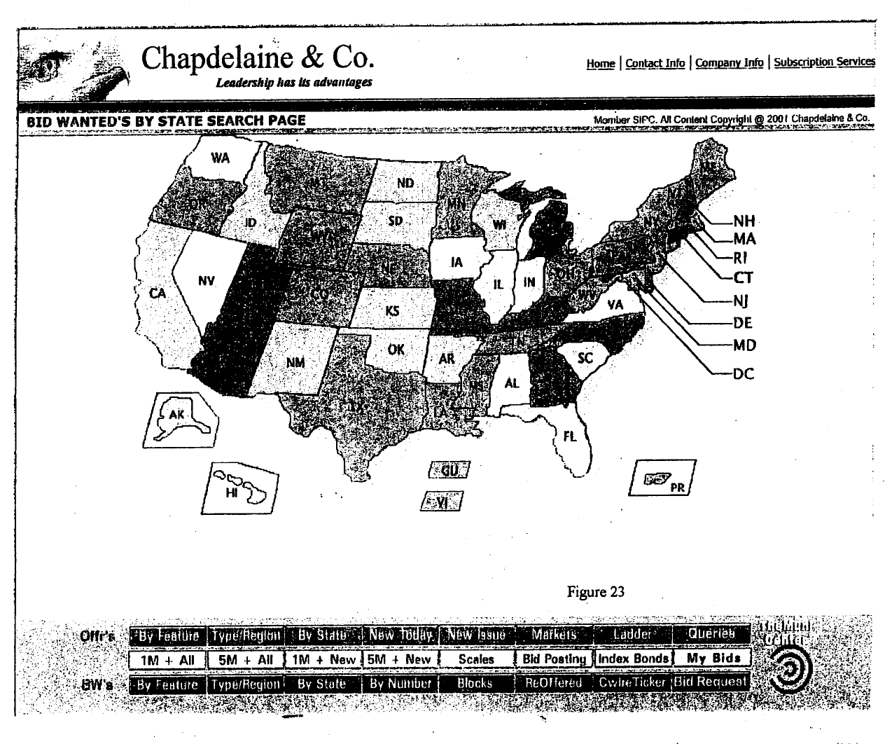

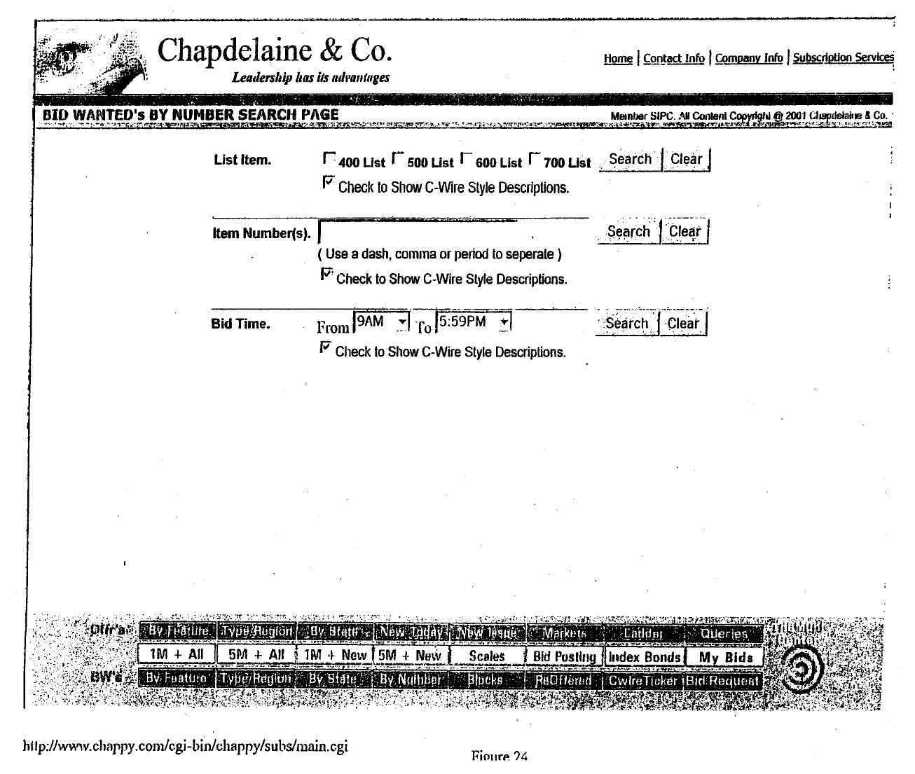

In addition to searching and analyzing bond offerings, the invention also affords the user the opportunity to search bid wanteds, which are listings of bonds as to which bids are being solicited. The system collects available listings of bid wanted items that potential purchasers can place bids on. Once again, as in the case of bond offerings, the user may interact with the system and establish parameters for searching bid wanteds listings, which parameters may include specific features of the bonds, such as type, state and/or region, identification number, and blocks or groups of bonds. For example, as with bond offerings discussed above, the user can perform such a search “By Feature,” “By Type/Region” or “By State,” as illustrated in FIGS. 21-23. As to these three criteria, the bid wanteds icons serve the same function as the corresponding icons for offerings.

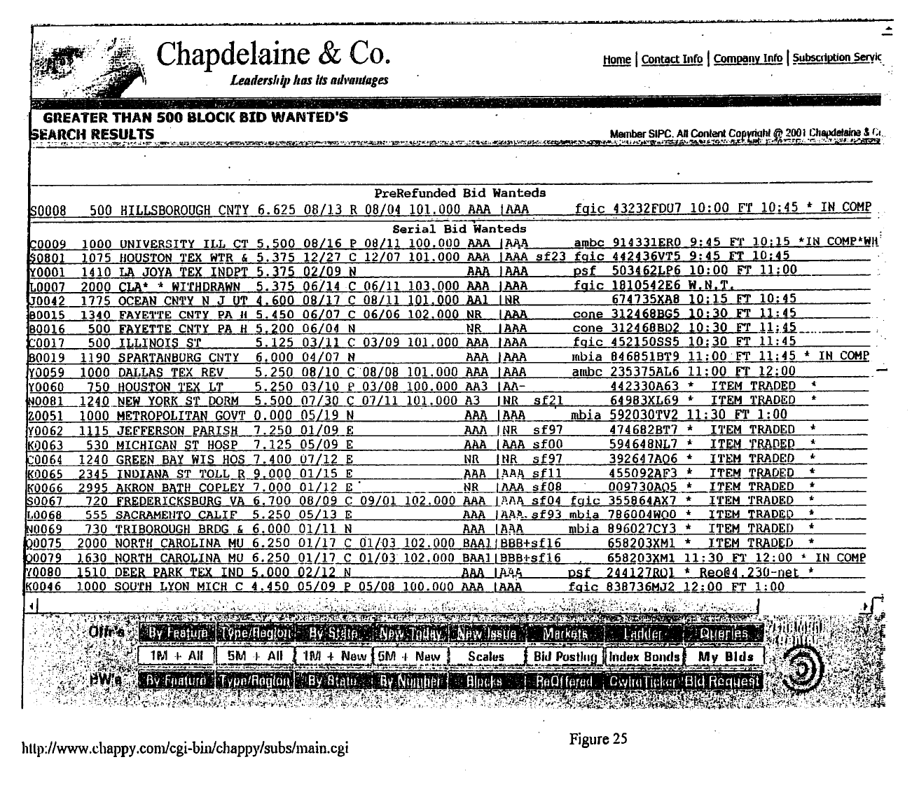

In addition, a user may search bid wanteds by “Number” or “Blocks.” The “By Number” icon allows the viewer to call up an individual, group, or all bid wanted items displayed on the system, as shown in FIG. 24. The “Blocks” icon displays blocks of items of $500,000 or more that are available for bid, as shown in FIG. 25.

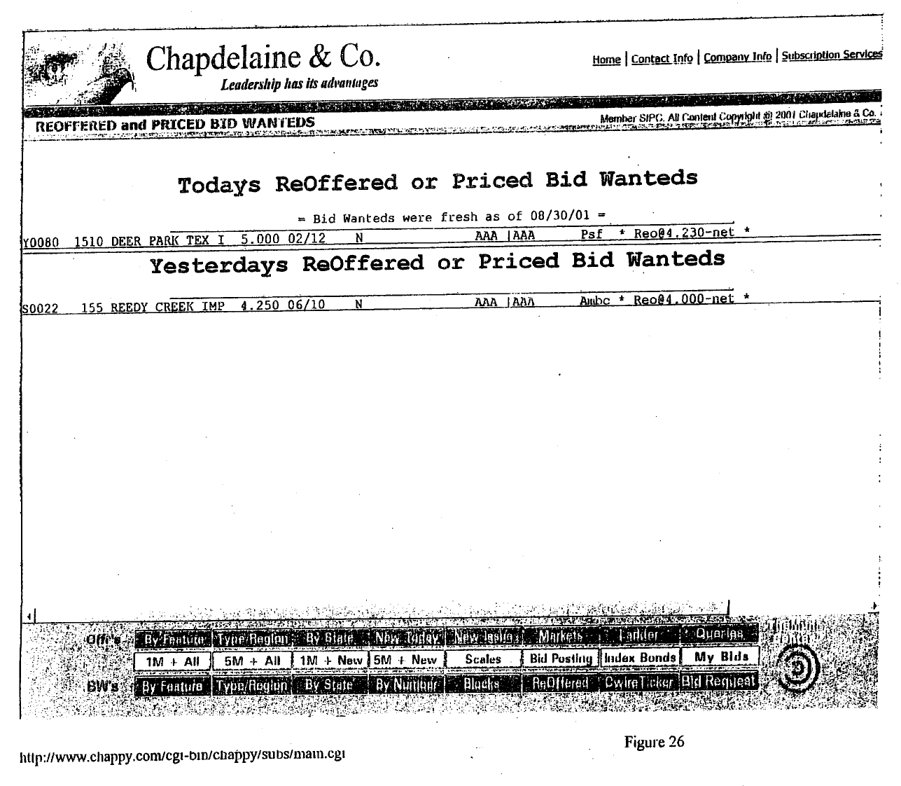

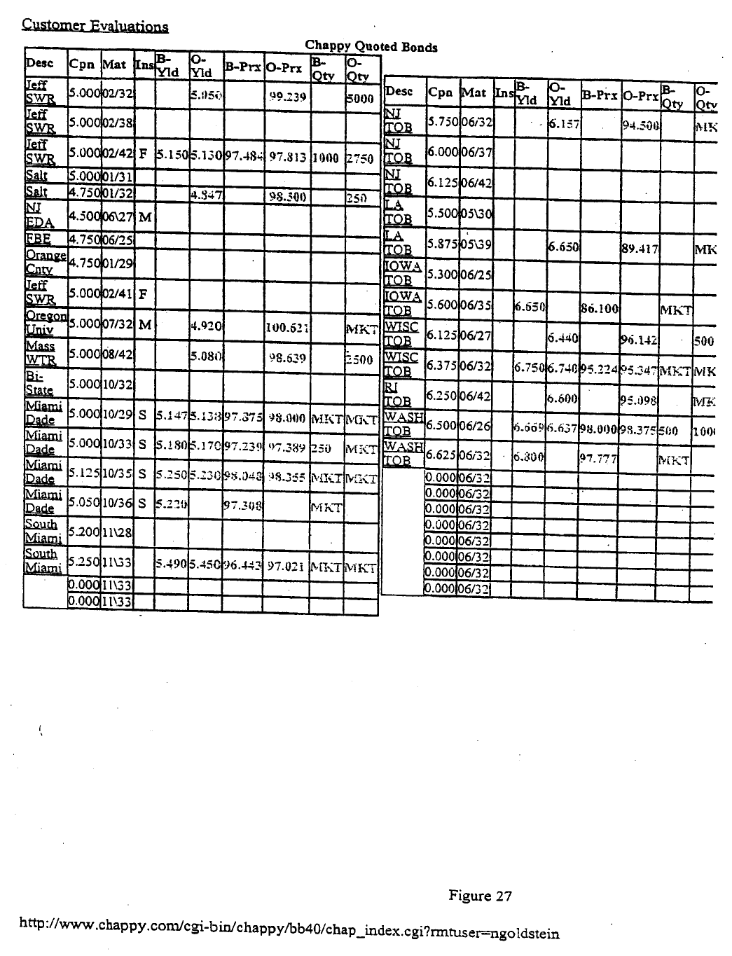

Bid wanteds may also be searched using the “Reoffered” icon, as shown in FIG. 26. This selection displays the reoffered price of a previously traded security or the price desired by an owner if a bond listed for a bid wanted has not traded. The “Reoffered” feature is a very useful tool to the dealer community as it provides current as well as historical market information to any interested viewer. Further, the system allows the user to view “Quoted Bonds,” as shown in FIG. 27. Bonds within this group are usually actively quoted, or bid upon, in the market. Use of this icon will display longer term bonds, showing a bid and offered side for each such bond if available in the market.

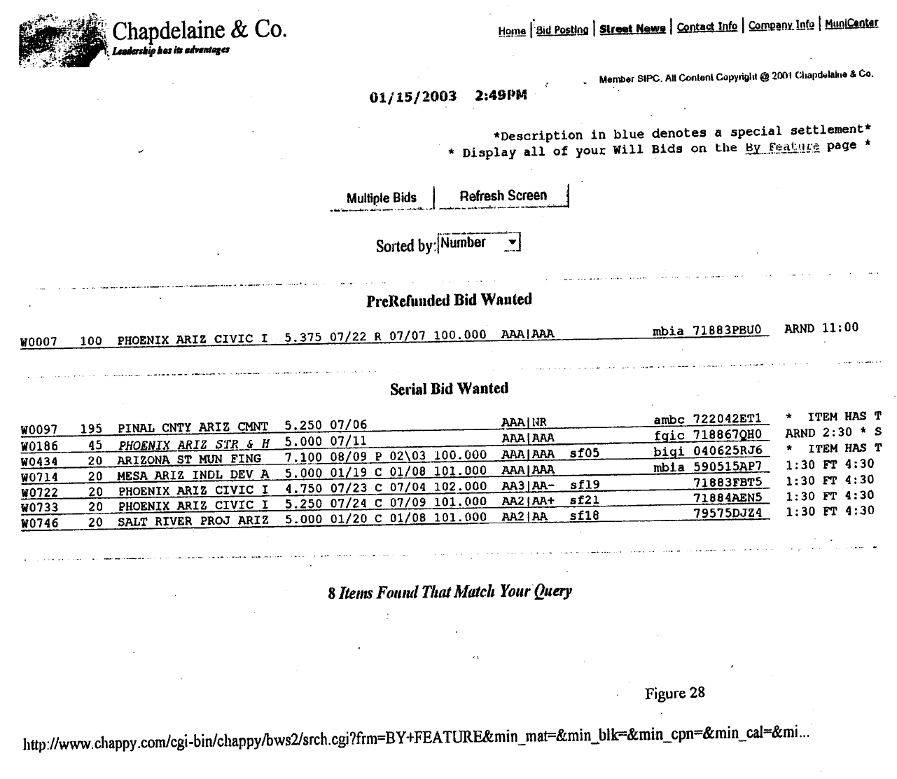

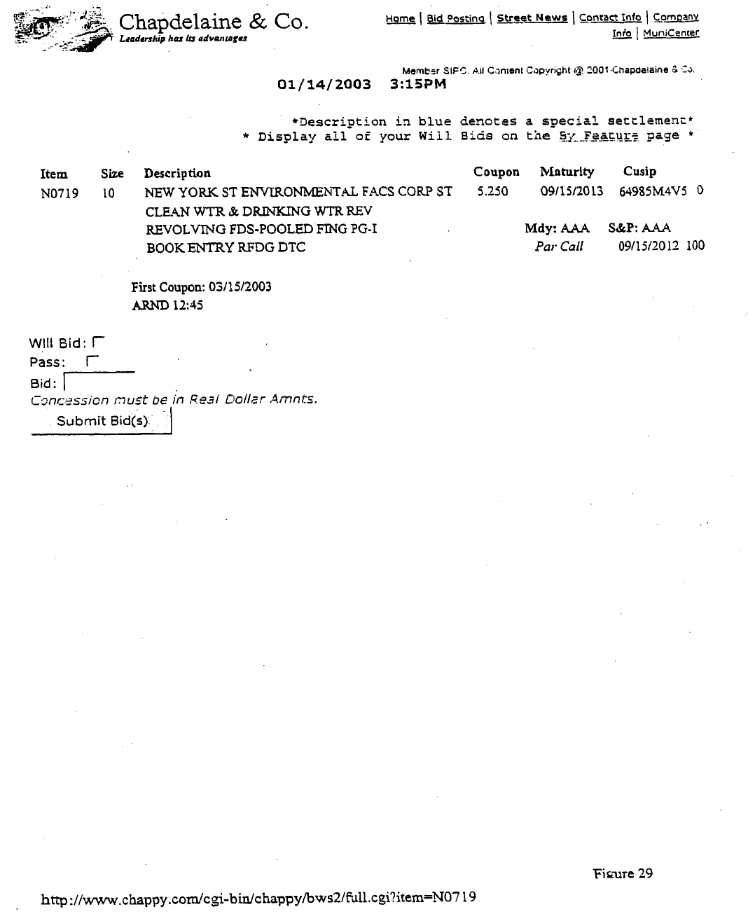

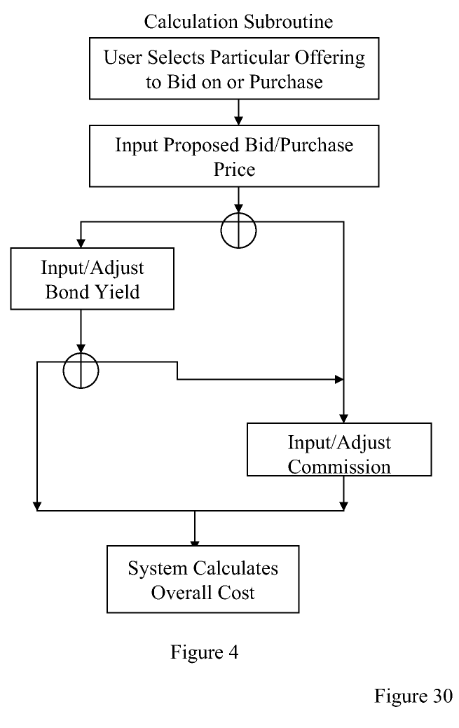

An innovative aspect of the system's bid wanteds search criteria is the “Multiple Bid Request,” as illustrated in FIG. 28. This feature of the invention is available to the viewer when performing a bid wanteds search using any bid wanteds search parameters. Bid wanteds searches for a specific type of bond produce a one-line description. Once the bonds are displayed, the user can click the multiple bid box and the system reformats, displaying a full description with the bid box present, along with a “Will Bid” and “Pass” button, as shown in FIG. 29. The viewer may bid on certain items, skip others, or select “Will Bid” on still others, meaning that the viewer intends to bid in the future. After the user enters his choices into the system, the invention brings the selected bonds back, and all listed bids by the user are displayed in view for each bond. This new display also constitutes notification to the bidder that his or her bids are accepted or rejected. Subsequent requests for the same bid wanteds searches will also display all bids previously submitted, as well as each bond still available for the bid. Only after a bid is submitted, the bond has traded, or the time to bid has expired will the system of the present invention remove the bid box display with respect to the selected bond.

As was the case with bond offerings, any bid wanteds searches and search results may be saved and retrieved on the system at the user's option.

Once a user has identified particular bond offering he or she may wish to bid on, he may request the system to perform a calculation, based on a certain proposed bid price, to determine the overall cost of the purchase, as illustrated in FIG. 30. In particular, the user may input and adjust such cost parameters as the bond's yield, price and/or commission, as may be dictated by the purchaser's own requirements for the prospective resale of the bond following the execution of his purchase. A calculation is automatically performed by the system, based on the indicated cost parameters, so that the user may determine and compare the overall cost of a purchase according to different cost parameters, and determine the price he may wish to establish at resale.

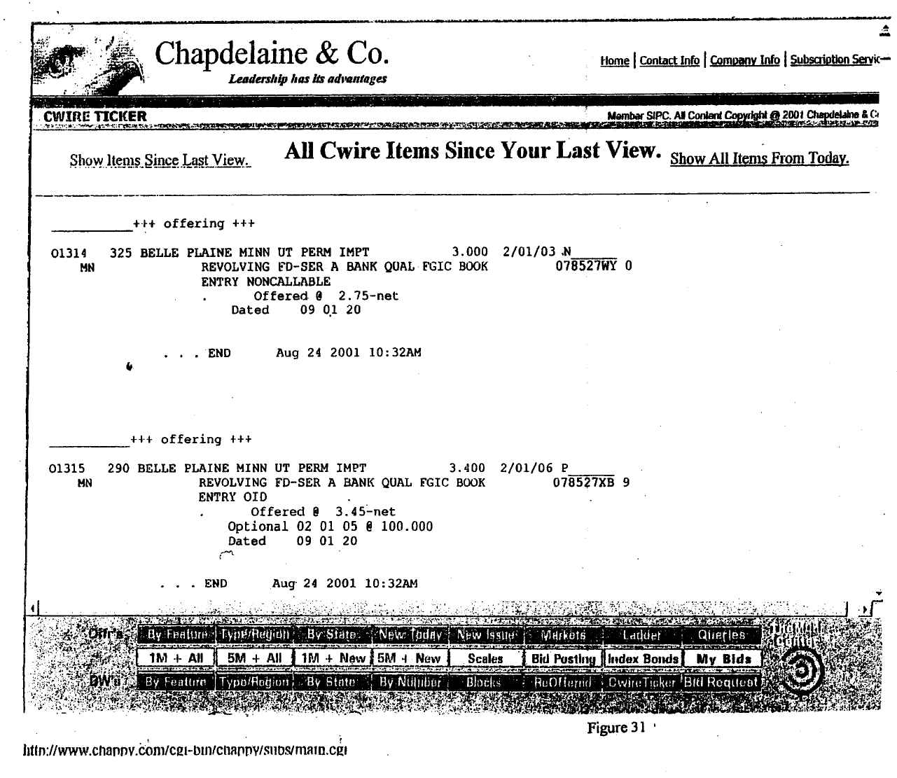

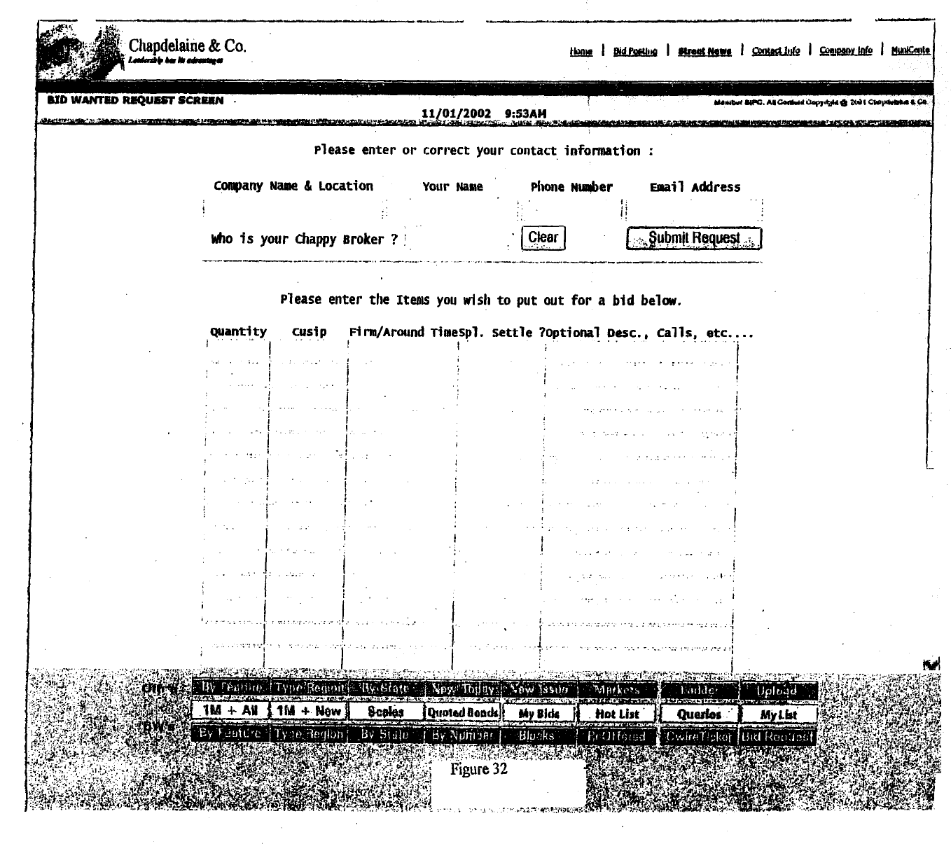

The C-wire icon searches and displays the bid wanteds listings that are most recently transmitted to the C-Wire ticker, or any other service that offers up-to-date information on bond purchases and sales, as shown in FIG. 31. This feature of the invention is continuously updated.

The system also has a bid request feature that enables the prospective seller of the bonds to submit requests for bids quickly and easily to the system. Use of the “Bid Request” function allows the bond to be electronically submitted to the system for the bid. As shown in FIG. 32, this feature of the invention requires the customer to complete certain fields on his screen and submit the bid request.

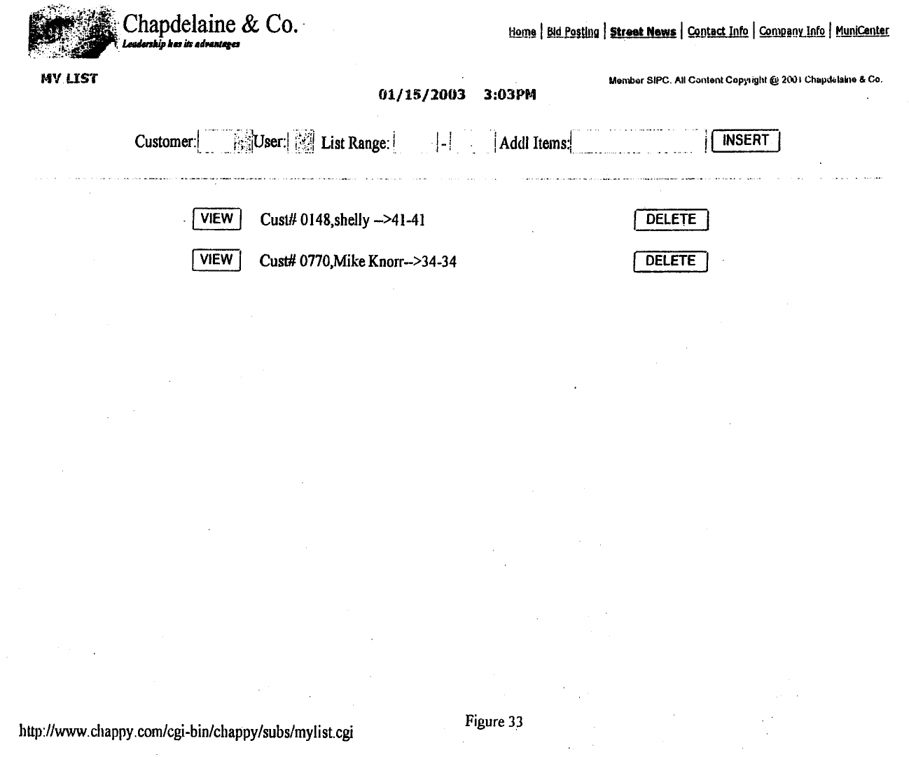

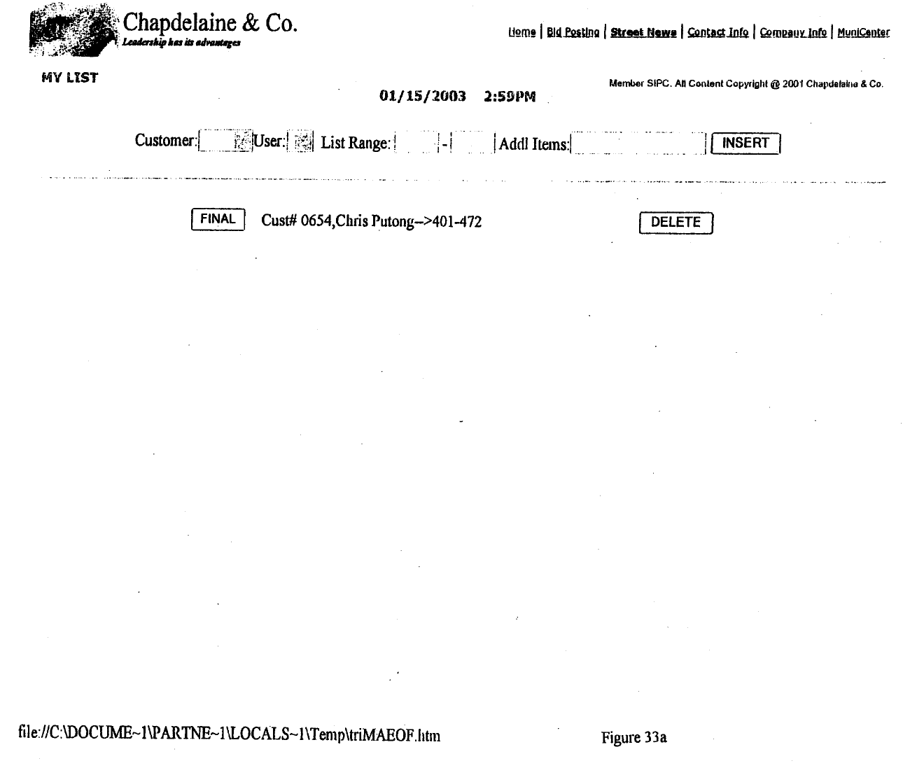

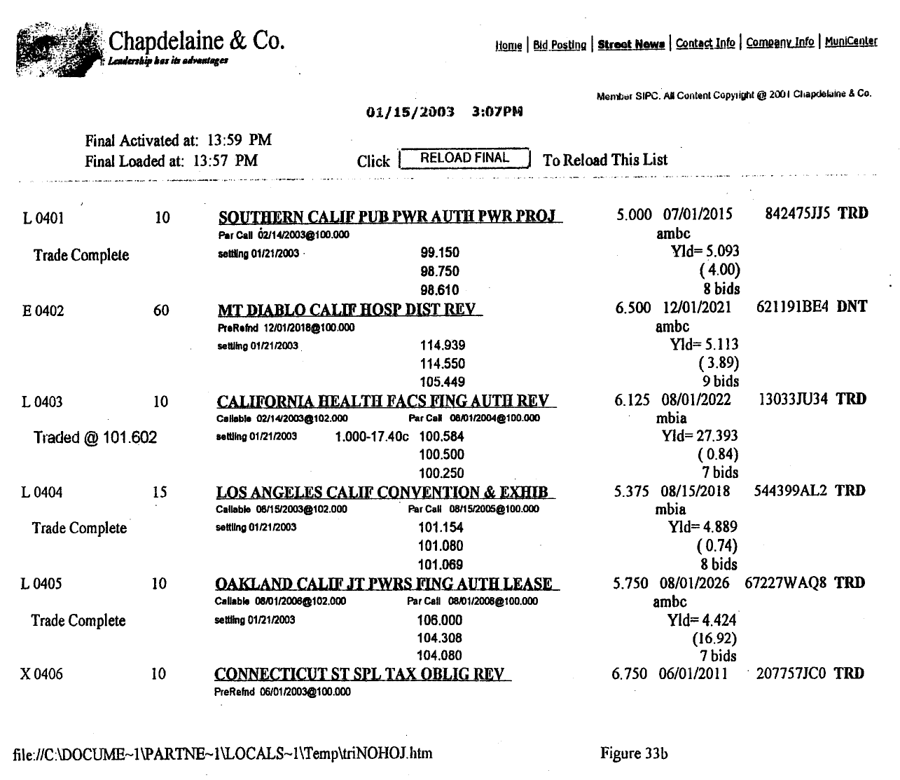

A special feature available to prospective sellers of bonds in connection with bid wanteds is “My List,” as illustrated in FIG. 33, 33a and 33b. This feature allows the system to create a profile for a particular bond owner's items, which are submitted as bid wanted. The profile creates and displays the top three bids that have been received on each bond. Bid wanted items can be entered into the system either by the customer or by the broker.

Once the items are entered, the customer may view bids submitted against his bid wanteds in the “My List” section, by selecting his profile. As bids are aggregated and approved by the broker, bids submitted on these items can be viewed by the customer. After the broker has reviewed and activated the list, the customer has the ability to mark each item on his or her list either for sale or “will not trade.”

To activate this feature, the broker selects the “My List” icon on his or her computer screen. Once selected, the “My List” icon will allow the broker to create the desired profile by selecting the customer's number from the customer's information stored on the invention. After selecting the customer information, the broker will enter the corresponding number for each bid wanted item and then select the “Insert” button on his or her computer screen as illustrated in FIG. 33. The “Delete” button on the screen allows the broker to correct any errors, and start the process anew.

To access the “My List” feature, the customer will select the “My List” icon and will see the list created by the broker by selecting the “View” button. Changes in the bids received against the bid wanteds on the list, are reflected in color changes of the “View” button. The color red indicates that the list is being prepared and is not viewable. The color yellow indicates that list is viewable and any approved bids can be seen but not acted upon by the customer. The color green, once activated by the broker, enables the customer to mark the bid wanted items.

After the customer selects the “View” button, he or she will see the top three bids against each bid wanted that have been approved by the broker. The customer will review each item and may mark each item as a Will Not Trade (WNT), or as a Sell, by selecting the appropriate radio button. Once the customer has marked his or her items, the responsible broker is notified by the invention that the customer has marked items either for sale or as a Will Not Trade.

After the customer has marked the list for sale, the “View” button will automatically change a “Review” button, where he or she can review the actions the broker has been instructed to take. The broker will then receive a message advising that the customer has marked the list for sale. Upon seeing this message, the broker will take the appropriate action.

Once the bonds listed for bid wanteds on a customer's “My List” are sold, the broker will activate the “Final” button for the list, allowing the custom to view the final trade results. The customers will see the final button change to green and will be able to view the final prices of the traded items, with the appropriate dollar price for each as well as the average dollar price and total par amount traded. The system will display any trade occurring at a higher level than previously marked by displaying the better price using the color red. The invention allows the customer to view his listed bid wanted items during the entire bid wanteds process, and delivers a final report with respect to each bond.

If the user allows the time advertised on the system for the completion of a bid wanted to expire, the invention will prevent the customer from marking any expired item for sale by removing the radio buttons “S” button from his or her screen. Once the customer loses the ability to mark an item for sale on the system, he or she may still call his broker to accomplish the sale.

The preferred embodiment of the system ensures the privacy of a user, by requiring each user to have a user ID and password, and to be “authorized” each time he wishes to use the system. Saved searches and search results may be retrieved only by the user who stored them on the system.

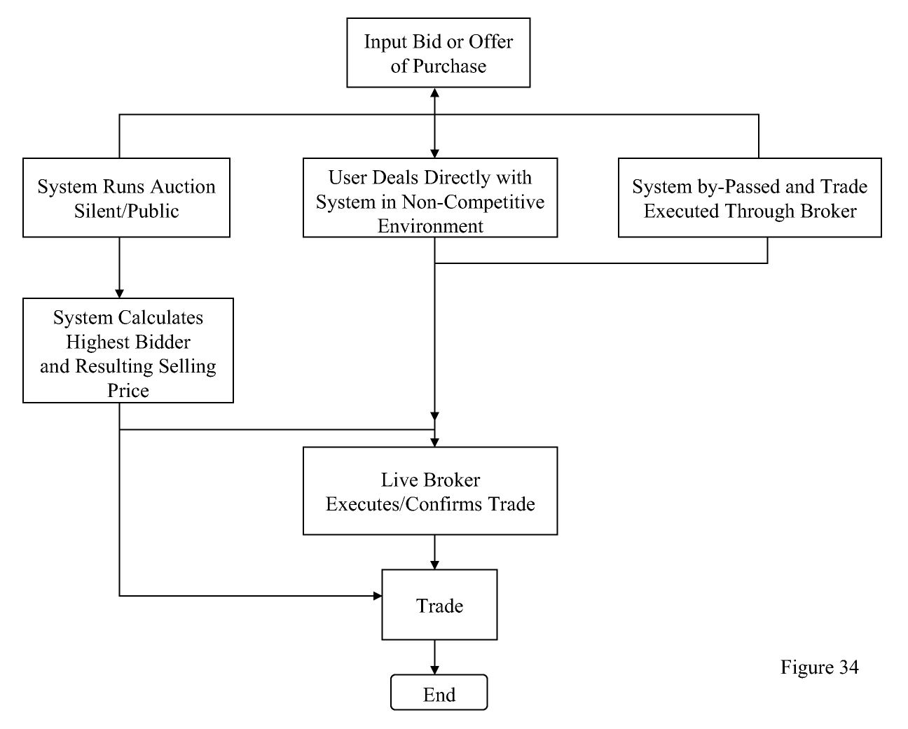

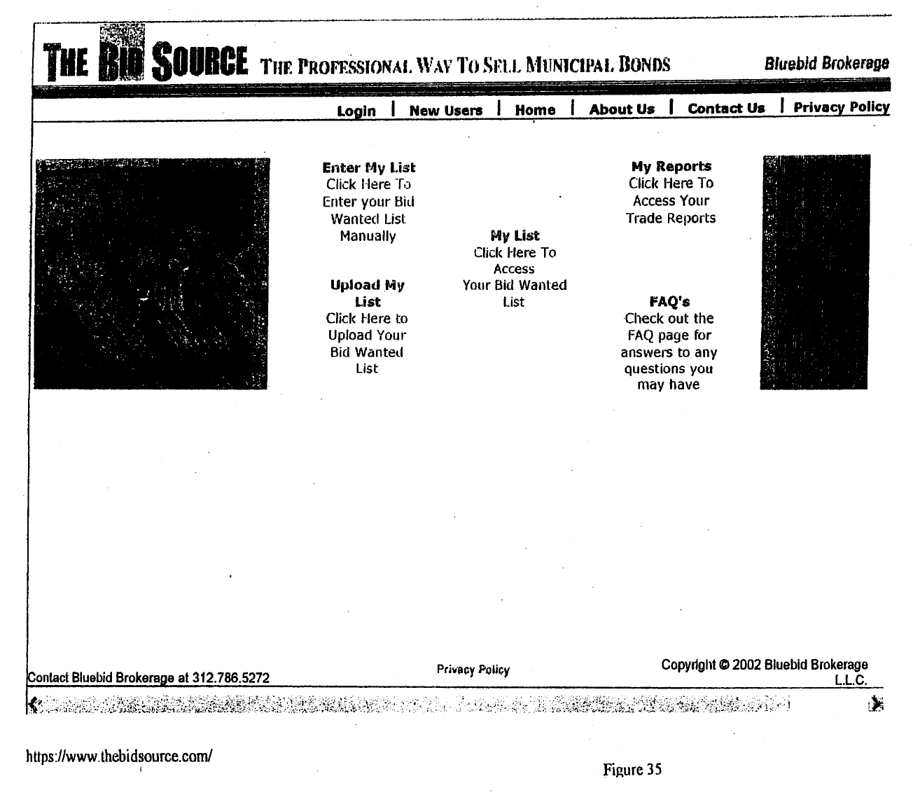

In addition to its original and innovative interactive search features, the system also affords the user the opportunity to bid on and execute purchases and trades of municipal bonds as shown in FIG. 34. Bids may be entered by multiple users in an auction format, either at silent auction, i.e., where the bidder is not aware of the status of other bidders' bids, or at live or public auction, whereby all bidders are provided with up-to-date information about the status of competitive bids. In either case, the system has the capability to determine the highest bidder and immediately calculate the selling price. Another manner of bidding is in a non-auction format, i.e., directly by the bidder to the system, which may result in a direct purchase of the bond. Any purchases or trades, whether at auction or direct, may be completed automatically by the system, or, at the broker's option, may require the intervention of a broker to execute or confirm the trade. The system also affords the user the ability to submit a bid in response to a bid wanted directly with the responsible broker.

There are, at minimum, three situations involving direct competitive or non-competitive bidding where the system allows for the intervention of a live broker. The first situation occurs when a municipal bond owner directs the broker to post a bond offering to the system. The broker does so and may begin contacting prospective buyers of this new bond. The broker may point out the new bond to prospective buyers, and solicit their interest. Should the broker receive a bid for this new bond, he will present the bid to the owner. The owner may elect to sell the bonds at that time, or make a counter-offer the broker will convey back to the bidder. This back and forth process may continue until a trade is completed or a final offer and final bid are made, without completion of a trade. The intervening broker may also post the original offering price, and any bids and counter-offer(s) on the system as current information to the general viewing market. Once this market information is posted on the system, any prospective user of the system may view the information as current market information and determine whether he wishes to bid on or purchase the bond.

The second situation occurs in a bid wanted situation, whereby using the system's “bid request screen,” a bond is submitted for competitive bid to the responsible broker. The system advertises the item as a competitive bid wanted on behalf of an undisclosed principal. The responsible broker supplements the listing of the bid wanted on the system through direct contact with prospective bidders and solicits the bids. Interested bidders may also use the system's electronic bid function to submit their bids. The system also allows each bidder to view his or her own bidding history for each bond he or she has bid on. In addition, the responsible broker may contact prospective bidders to ensure they have seen the bid wanted item on the system and have had the opportunity to bid. The broker will then convey to the owner of the bond the best bid submitted (whether via the system or by direct contact) and will await the owner's decision to sell or hold. If the owner does not elect to sell the bonds based on the bids submitted, the broker may ask the owner for a price at which the owner would sell his or her bonds.

The third situation occurs in a “get a price” situation, whereby the municipal bond owner gives the broker a price following a bid wanted with instructions to post each bidder and post the price on the system. Once the new price is posted on the system, all viewing customers will see the new price and this new price may begin a new round of bidding, using the system or by voice directly with the broker. The process will be repeated as described in the first situation above until a trade is completed or another final bid and offer are made and posted on the system, thereby displaying the most current bid/offer market information.

The system of the present invention also provides a unique service to third parties, such as to one or more NASD Broker Dealers, to allow such parties themselves to interface with their customers, and make available to such customers the bid wanted process of the present invention. This feature provides access to the bid side of the bond market and enables the dealer's customer to send an order to execute a bid wanted item. The invention will allow the dealer or the dealer's customer to list the bonds for the bid. Once entered, the invention will collate and organize all bids received in a clear and concise manner and inform the customer of bids on various bonds. Thus, the dealer is able to offer its customer, the bond owner, the ability to interface with the system and mark his or her items for sale or “will not trade.” This feature also provides a number of administrative capabilities to the broker-dealer. He or she can add or delete; bonds to a list of bid wanted items as well as alter the sell or will not trade status of any unsold items. The broker dealer can also add or delete clients to or from the system.

The above-described system provides a user-friendly, convenient and inexpensive method for users to search, identify, analyze and compare prospective municipal bond purchases according to key criteria used in the municipal bond industry, to store and retrieve such searches, to calculate the cost of prospective purchases, to search for, store and retrieve bid wanteds information, and to bid on and execute purchases, with or without the intervention of a live broker, thereby increasing the business of the broker responsible for operating the system. The preferred embodiment is browser-based, and may be accessed by the user at any computer terminal. However, the invention may be adapted to any electronic-based system that exists or may be devised in the future.

While the foregoing description of the present invention has been particularly described in conjunction with a preferred embodiment, it will be appreciated by those of ordinary skill in the art that the description of the preferred embodiment set forth above is for illustrative purposes

1. An interactive information host web-server for hosting an electronic broker's brokerage of municipal bonds comprising;
an interface for connecting to a plurality of web-clients via the Internet: one of said clients operated by a broker's-broker; one of said web-clients operated by a selling broker-dealer and a remainder of said web-clients being operated by additional broker-dealers;
at least one processor connected to said interface and operable to receive a bid-wanted request originating from said selling-broker dealer; said processor operable to receive a search-request from at least a portion of said additional broker-dealers; said at least a portion of said additional broker-dealers being possible bidding broker-dealers; said search request including parameters matching said bid-wanted request;
said processor operable to present said bid-wanted request to said portion of said additional broker-dealers, and to receive bids from at least a portion of said bidding broker-dealers, and to present said bids to said broker's-broker for approval;
said processor operable to receive input from said broker's-broker representing said approval for inserting said bids into a list of top ones of said bids, and to present said list to said selling broker-dealer; and
said processor operable to receive a marking from said selling broker-dealer representing whether said remote broker-dealer will not sell or will sell said at least one municipal bond presented in said list.

2. The web-server according to claim 1 further comprising means for storing said search-requests and said results of said search-requests in a database.

3.-6. (canceled)

7. The web-server according to claim 1 in which said search-request includes at least one of maturity year, coupon, size, price, yield, call year, ratings, and insurance.

8. The web-server according to claim 1 in which said search-request comprises a by-state search.

9. The web-server according to claim 1 in which said search-request comprises a by-region search.

10. The web-server according to claim 1 in which said search-request includes a by-type search, comprising at least one of non-callable, Housing, zero coupon, bank qualified, hospitals, pre-refunded, Escrowed to Maturity, AMT Bonds, Sinking Fund, Dollars, taxable, junk bonds and tobacco debt issues.

11. The web-server according to claim 1 in which the additional broker-dealers can exclude financial instruments satisfying at least one of said by-type criteria from said search-request.

12.-13. (canceled)

14. The web-server according to claim 1 further comprising means for enabling said buying broker-dealer to perform said search-request over a broad maturity range.

15.-16. (canceled)

17. The web-server according to claim 1 wherein results of said search-request are returned to said web-client in a format having a unique hyperlink corresponding to each municipal bond identified by said search which, upon activation, presents the buying broker-dealer with detailed information on said municipal bond.

18.-20. (canceled)

21. A method of operating a web-server hosting an electronic broker's brokerage of municipal bonds comprising:
receiving a bid-wanted request for at least one municipal bond from a remote broker-dealer interacting with said web-server via a first web-browser;
storing said bid-wanted request;
receiving a plurality of search-requests including parameters matching said bid-wanted request; said search-requests received from a plurality of additional remote broker-dealers interacting with said web-server via a plurality of additional web-browsers;
responsive to each said search-request, presenting said bid-wanted request to said plurality of additional remote broker-dealers;
responsive to presenting said bid-wanted request, receiving a plurality of bids respective to said bid-wanted request from at least a portion of said plurality of additional remote broker-dealers via each said respective additional web-browsers:
presenting said bids to a broker's-broker for approval via a third web-browser respective to said brokers-broker:
based on input representing approval by said broker's-broker received via said third web-browser, inserting one or more of said bids into a list aggregating a selected number of top ones of said bids;
presenting said list to said remote broker-dealer via said first webbrowser; and
responsive to presenting said list to said first remote broker-dealer, receiving a marking from said first remote broker-dealer via said first web-browser; said marking representing whether said remote broker-dealer will not sell or will sell said at least one municipal bond.

22. The method of claim 21 further comprising:
executing a trade of said at least one municipal bond if said marking reflects said remote broker-dealer will sell said at least one municipal bond.

23. The method of claim 22 further comprising:
preparing and presenting a final report detailing the result of performance of executing said trade.

24. The method of claim 21 wherein said selected number of top ones of said bids is one, two, or three.

25. The method of claim 21 wherein said request includes a quantity of said at least one municipal bond.

26. The method of claim 21 wherein said request includes a Committee on Uniform Security Identification Procedures (“CUSIP”) number identifying said at least one municipal bond.

27. The method of claim 21 wherein said request includes a Firm/Around Time.

28. The method of claim 21 wherein said request includes at least one of terms of Special Settlement, Optional Description and Calls.

29. The method of claim 1 wherein said parameters include at least one of CUSIP, type, state, region, size, coupon, price, yield, call year, and ratings.

30. The method of claim 21 wherein said presenting said list only occurs after of said list is completely aggregated.

31. A method of operating a web-server hosting an electronic broker's brokerage of municipal bonds comprising:
receiving a bid-wanted request for at least one municipal bond from a remote broker-dealer interacting with said web-server via a first web-browser;
storing said bid-wanted request;
receiving a plurality of search-requests including parameters matching said bid-wanted request; said search-requests received from a plurality of additional remote broker-dealers interacting with said web-server via a plurality of additional web-browsers;
responsive to each said search-request, presenting said bid-wanted request to said plurality of additional remote broker-dealers;
responsive to presenting said bid-wanted request, receiving a plurality of bids respective to said bid-wanted request from at least a portion of said plurality of additional remote broker-dealers via each said respective additional web-browsers;
presenting said bids to a broker's-broker for approval via a third web-browser respective to said broker's-broker;
based on input representing approval by said broker's-broker received via said third web-browser, inserting one or more of said bids into a list aggregating a selected number of top ones of said bids;
during said inserting step, presenting said list in as a preview-list to said remote broker-dealer via said first web-browser for viewing;
upon completion of said inserting step, presenting said list as an active-list to said remote broker-dealer via said first web-browser; and
responsive to presenting said active-list to said first remote broker-dealer, receiving a marking from said first remote broker-dealer via said first web-browser; said marking representing whether said remote broker-dealer will not sell or will sell said at least one municipal bond.

32. The method of claim 31 wherein said preview-list excludes an amount of said bid.

33. The method of claim 31 further comprising:
presenting a notification-button to said remote broker-dealer via said first web-browser for viewing; said notification-button being presented in a first colour that represents that said list has not been aggregated.

34. The method of claim 33 further comprising:
presenting a notification-button adjacent to said preview-list to said remote broker-dealer via said first web-browser; said notification-button being presented in a second colour that represents that said preview-list is being aggregated and is not ready for marking.

35. The method of claim 34 further comprising:
presenting a notification-button adjacent to said active-list to said remote broker-dealer via said first web-browser; said notification-button being presented in a third colour that represents that said active-list is ready for marking.

36. The method of claim 35 wherein said first colour is red and said second colour is yellow and said third colour is green.

37. The method of claim 31 wherein a bid-wanted request is received for a plurality of municipal bonds so that a plurality of bid-wanted requests are received; and wherein bids are received for each said bid-wanted request; and wherein said lists each includes responses respective to each said bid-wanted request; and each said bid-wanted request includes a selected number of top ones of said bids respective thereto.

38. A web-server for hosting an electronic broker's brokerage of municipal bonds comprising:
means for storing a bid-wanted request; said bid-wanted request for at least one municipal bond from a remote broker-dealer; said remote broker-dealer having means for interacting with said web-server via a first web-browser;
means for receiving a plurality of search-requests including parameters matching said bid-wanted request; said search-requests received from a plurality of additional remote broker-dealers interacting with said web-server via a plurality of additional web-browsers each respective to said plurality of additional remote broker-dealers;
means, responsive to each said search-request, for presenting said bid-wanted request to said plurality of additional remote broker-dealers;
means, responsive to presenting said bid-wanted request, for receiving a plurality of bids respective to said bid-wanted request from at least a portion of said plurality of additional remote broker-dealers via each said respective additional web-browsers;
means for presenting said bids to a broker's-broker for approval via a third web-browser respective to said broker's-broker;
means, based on input representing approval by said broker's-broker received via said third web-browser, for inserting one or more of said bids into a list aggregating a selected number of top ones of said bids;
means for presenting said list to said remote broker-dealer via said first web-browser; and
means, responsive to presenting said list to said first remote broker-dealer, for receiving a marking from said first remote broker-dealer via said first web-browser; said marking representing whether said remote broker-dealer will not sell or will sell said at least one municipal bond.

39. The web-server of claim 38 further comprising means for executing a trade of said at least one municipal bond if said marking reflects said remote broker-dealer will sell said at least one municipal bond.

40. The web-server of claim 39 further comprising means for preparing and presenting a final report detailing the result of executing said trade.

41. The web-server of claim 38 wherein said selected number of top ones of said bids is one, two, or three.

42. The web-server of claim 38 wherein said request includes a quantity of said at least one municipal bond.

43. The web-server of claim 38 wherein said request includes a Committee on Uniform Security Identification Procedures (“CUSIP”) number identifying said at least one municipal bond.

44. The web-server of claim 38 wherein said request includes a Firm/Around Time.

45. The web-server of claim 38 wherein said request includes terms of Special Settlement.

46. The web-server of claim 38 wherein said request includes at least one of Optional Description and Calls.

47. The web-server of claim 38 wherein a bid-wanted request is received for a plurality of municipal bonds so that a plurality of bid-wanted requests are received; and wherein bids are received for each said bid-wanted request; and wherein said lists each includes responses respective to each said bid-wanted request; and each said bid-wanted request includes a selected number of top ones of said bids respective thereto.

48. A web-server for hosting an electronic broker's brokerage of municipal bonds comprising: network interface for connecting to a plurality of web-clients via a network; at least one of said web clients respective to a broker's-broker and a remainder of said web-clients; a processor connected to said network interface; said processor configured to execute programming instructions; said programming instructions configured to cause said processor to be operable to receive a bid-wanted request for at least one municipal bond from one of said remote broker-dealers via said network interface, said one of said remote broker-dealers being designated a selling broker-dealer; a storage device connected to said processor and for storing said bid-wanted request; said programming instructions additionally configured to cause said processor to be operable to receive a plurality of search-requests from a plurality of additional ones of said remote broker-dealers via said network interface; each said additional ones of said remote broker-dealers being designated a possible bidding broker-dealer; said programming instructions being configured to cause said processor to respond to each said search-request by retrieving said bid-wanted request from said storage device and presenting said bid wanted request to said possible bidding broker-dealers via said network interface; said programming instructions being configured to cause said processor to be operable to receive a plurality of bids respective to said bid-wanted request from at least a portion of said potential bidding broker-dealers; said programming instructions being configured to cause said processor to be operable to present said bids to said broker's-broker at said broker's-broker web client; said programming instructions further being configured to be responsive to input representing approval of said bids by said broker's-broker; said input causing said processor to insert one or more of said bids into a list aggregating a selected number of top ones of said bids; said programming instructions being configured to cause said processor to be operable to present said list to said selling broker-dealer via said selling broker-dealer's web-client; and, said programming instructions being configured to cause said processor to receive a marking from said selling broker-dealer via said selling broker-dealer's web-client; said marking representing whether said remote broker-dealer will not sell or will sell said at least one municipal bond presented in said list.
